(19) United States
(12) Patent Application Publication
(10) Pub. No.: US 2001/0038287 A1
(43) Pub. Date: Nov. 8, 2001

(54) Logging tool for measurement of resistivity through casing using metallic transparencies and magnetic lensing

(76) Inventor: Bijan K. Amini, Houston, TX (US)

Correspondence Address: WENZHONG LIU, 6721 THOMAS BLVD, APT 26, PITTSBURGH, PA, 15208, US

(21) Appl. No.: 09/781,667

(22) Filed: Feb. 12, 2001

Related U.S. Application Data
(60) Provisional application No. 60/229,983, filed on Sep. 2, 2000.
(60) Provisional application No. 60/166,695, filed on Nov. 20, 1999.
(60) Provisional application No. 60/166,693, filed on Nov. 20, 1999.
(60) Provisional application No. 60/166,696, filed on Nov. 20, 1999.
(60) Provisional application No. 60/222,982, filed on Aug. 4, 2000.

(51) Int. Cl. G01V 3/10

(52) U.S. Cl. 324/341

(57) ABSTRACT

A method and apparatus for transmitting electromagnetic flux through well casing or similar materials to measure or detect the electrical resistivity of media in the surrounding geologic formation. The invention creates a magnetically transparent region in an electromagnetic barrier material, e.g., ferromagnetic metal well casing. It further incorporates a transmitter sending an electromagnetic wave at a selected frequency and strength, and a receiver to measure returning signals. The method and apparatus may also incorporate the controlled use of electromagnetic barrier material that can be wholly or partially saturated with electromagnetic energy in order that the electromagnetic wave transmitted by the invention can be focused in a controlled manner.

### CROSS REFERENCE TO RELATED APPLICATIONS

This application claims the benefit of U.S. Provisional Application No. 60/229,983, entitled “A Logging Tool For Measurement of Resistivity Through Casing Using Metallic Transparencies and Magnetic Lensing,” filed Sep. 2, 2000; U.S. patent application Ser. No. 09/672,467, entitled “Magnetic Saturation and Coupling,” filed Sep. 28, 2000, which in turn claims benefit of U.S. Provisional Application No. 60/166,695, filed Nov. 20, 1999; U.S. patent application Ser. No. 09/672,755, entitled “Magnetic Lensing,” filed Sep. 28, 2000, which in turn claims benefit of U.S. Provisional Application No. 60/166,693, filed Nov. 20, 1999, U.S. Provisional Application No. 60/166,696, entitled “Spectral EM Frequency Metallic Thickness Measurement using Metallic Transparencies,” filed Nov. 20, 1999, and U.S. Provisional Application No. 60/222,982, entitled “Measurement of Electrical Properties Through Saturated Permeable Metals Using Directed Magnetic Beams and Magnetic Lenses” filed Sep. 1, 2000.

### BACKGROUND OF THE INVENTION

1. Field of Use

Any medium containing electrically conductive material can be monitored for changes in the electrical resistivity of the electrically conductive material within the medium. An important and well known example is the measurement of the electrical resistivity of underground geologic formations Such formations often contain salt water, which is a relatively high electrically conductive material and/or hydrocarbons which are less electrically conductive and therefore more electrically resistive. The resistivity of geologic formations containing these materials is measurable, thereby providing information relative to the concentrations of oil, water and gas at various locations within a geologic formation.

It has been demonstrated that it is possible to measure the resistivity of an underground geologic formation through a ferromagnetic Well Casing penetrating the formation, as well as through other materials that are electrically conductive and magnetically permeable. These materials are referred herein as “EM Barriers” or “Barrier Materials.” The technology is based upon inductive magnetic coupling, therefore the measuring apparatus does not need to be in physical contact to the Barrier Material comprising the well casing or production tubing. The invention subject of this specification utilizes this technique to measure the resistivity of geologic formation beyond the well casing. The fact that the invention does not require physical contact with the surface of the casing or tubing material facilitates movement of the logging tool within the interior of the tubing or casing along the axis of the well. It also minimizes the wear upon the logging tool housing and other components.

Hydrocarbon production wells typically utilize an outer casing made of a ferromagnetic material. Common outside diameters of the casing may be of a range of 7 to 10 inches or larger. The interior diameter is of varying dimensions. The thickness of the casing also varies but may typically be ½ inch or more in thickness. Placed inside the permanent casing is a smaller production tubing. The outer diameter of the production tubing may be in a range of 1 to 4 inches. Hydrocarbon, such as crude oil mixed with salt water or solid particles such as sand, flows through the production tubing at a high velocity. This environment is harsh and corrosive, sometimes requiring the replacement of the production tubing.

Note that throughout this specification, the terms “Casing” and “Well Casing” will be deemed to include hydrocarbon production tubing or other ancillary structures such as casing or tubing connectors or couplings that may be installed inside of the well casing.

The Logging Tool of this invention creates a Metallic Transparency”™ local to its oscillating magnetic flux transmitter (Transmitter) and its flux signal receiver (Receiver) by means of a strong magnetic flux field saturating the proximate portion of the Barrier Material comprising the Well Casing near the Transmitter and Receiver. It may also utilize partial saturation and Magnetic Lensing to direct the oscillating flux of the Transmitter in a controlled manner.

The present invention relates generally to measuring resistivity of media such as liquids, gases or other objects within a geologic formation surrounding a Well Casing. Specifically, the present invention relates to through casing resistivity measurement in downhole hydrocarbon production environments. The present invention provides an logging apparatus and method for measuring the resistivity of a formation proximate to a well. The current invention, in one embodiment, is an apparatus that can be moved inside the Casing of an oil or gas producing well for measuring the resistivity of the surrounding formation. The apparatus records magnetic signals that relate to the resistivity of the geologic formation at various depths or locations within the formation penetrated by the Cased well as the logging apparatus moves along the axis of the well. The apparatus can thereby detect the location and amplitude of said resistivity in single or multiple directions, and at distances that will help operators of wells adjust their production management and their reservoir management activities. The apparatus can also be used to detect changes in the resistivity of over time by comparison of recorded signals.

The invention includes a Logging Tool that can travel through the relatively narrow diameter of Well Casing (or production tubing), means to raise and lower the Tool, means to supply power and receive data, as well as recording and display devices.

2. Description of Related Art

In the development and production of oil and gas reservoirs, there is a very significant need to increase the amount and accuracy of information regarding the composition and changes in the composition of the resource-bearing zones of the formation. Resistivity measurement has long been used to characterize properties of the immediately surrounding substrates prior to the inception of production. However, it has typically only been possible to take such measurements prior to setting Casing or while the formation itself is otherwise “exposed” to the logging tool, i.e., an “open hole” without an interceding material that acts as a barrier between the logging tool and the formation substrate. Existing methods of measuring the resistivity of the media within a geologic formation have therefore required that the measurements be taken with logging tools deployed prior to commencement of actual production. After casing is placed in the well and production is underway, it is generally not possible to measure the resistivity of the surrounding geologic formation without interruption of the well production and penetration or removal of the Well Casing.

As is known to those skilled in the industry, the electrical resistivity of a geologic formation varies as a result of (among other reasons) the changing proportion of hydrocarbon to water contained within the formation. Having the ability to measure at selected locations and directions over time would provide for the unique ability to monitor, for example, the change in the percentage of water versus either oil, gas, or other electrically conductive materials approaching the well, far in advance of such change in fluids actually entering the well. The benefits of such measurements include the ability to see changes in the composition of the formation, i.e., hydrocarbon and water by measuring changes in the resistivity of the formation through the Barrier Material comprising the Well Casing.

Numerous attempts have been made to provide an apparatus or method for measuring the electrical resistivity of the surrounding geologic formation through a Well Casing. See for example U.S. Pat. No. 5,654,639 entitled “Induction Measuring Devices in the Presence of Metal Wall,” but requiring an electric current to be passed into the metal pipe wall. The contact device is then disengaged from the wall when the apparatus is moved. Also U.S. Pat. No. 5,426,367, entitled “Logging of Cased Well by Induction Logging to Plot an Induction Log of the Well” and stating the device “needs the most intimate contact with the pipe in order to eliminate ‘air gaps’ and still maintain mechanical integrity.” Column 8, Lines 40-43. U.S. Pat. No. 6,157,195, entitled “Formation Resistivity Measurements from within a Cased Well Used to Quantitatively Determine the amount of Oil and Gas Present,” also requires the transmission of an AC current through the Well Casing to a remote electrode. This is consistent with earlier patents such as U.S. Pat. No. 6,025,721, entitled “Determining Resistivity of a Formation Adjacent to a Borehole Having Casing by Generating Constant Current Flow in Portion of Casing and Using at Least Two Voltage Measurement Electrodes,” U.S. Pat. No. 5,260,661, entitled “Calibrating and Compensating Influence of Casing Thickness Variations on Measurements of Low Frequency AC Magnetic Fields within Cased Boreholes to Determine Properties of Geological Formations,” U.S. Pat. No. 5,065,100, entitled “Measurement of In-phase and Out-of Phase Components of Low Frequency AC Magnetic Fields within Cased Boreholes to Measure Geophysical Properties of Geological Formations,” and U.S. Pat. No. 5,038,107, entitled “Method and Apparatus for Making Induction Measurements Through Casing.”

Many of these methods have relied upon the transmission of an electrical current through the Casing and into the surrounding formation. All of the methods have required electrical contact be maintained between the apparatus and the Casing.

Thus, there has always been a need to provide the capability for continuous or periodic measurements of formation resistivity for a permanent hydrocarbon production well installation. Specifically, there has been a need to “see through” the Well Casing to the geologic formation located the production well. There also has long been a need to provide resistivity measurements without interruption of the hydrocarbon production well. There is also a great need for the ability to simultaneously (i) generate a magnetic flux, by conventional means, within the confines of a hydrocarbon production well, (ii) create magnetic transparency zone within or through the Well Casing of a hydrocarbon production well, (iii) engage or transmit through the Transparency with oscillating magnetic flux, and (iv) receive and measure through the Well Casing magnetic flux that may be generated in the media in the geologic formation outside of the Well Casing. It is already known to those skilled in the art that such measurements can provide information about the resistivity of media within the formation, and hence the composition or change in the media within the geologic formation proximate to the well.

### SUMMARY OF THE INVENTION

The invention subject of this specification provides a method and apparatus for measuring the electrical resistivity of the geologic formation proximate to a hydrocarbon production well installation. A measuring device (“Logging Tool”) is configured to allow it to be moved through the axial length of the Well Casing. Well Casing (including hydrocarbon production tubing) is commonly manufactured of materials that are electrically conductive and magnetically permeable. These materials are referred herein as “EM Barriers” or “Barrier Materials.” The present invention creates at least one Metallic Transparency within or through the Well Casing. A Metallic Transparency permits oscillating magnetic flux to be transmitted through the Casing.

The Logging Tool of the invention further includes the capability of generating magnetic flux to magnetically engage and saturate a portion of the Well Casing (utilizing a “Magnetic Transparency Generator” or “Saturation Inducer”), transmitting oscillating magnetic flux into or through the Transparency and measuring any oscillating magnetic flux generated by the eddy currents induced within electrically conductive material existing within the geologic formation, e.g., water or hydrocarbons. It will be readily understood that the transmission of oscillating magnetic flux into an electrically conductive material will induce an electric current, i.e., eddy current, by well know scientific principles. The present invention also provides the ability to perform these activities continuously as the Logging Tool is moved through the axial length of the Well Casing.

By altering the concentration of the Saturation Flux, the frequency of the Transmitter flux, placement of the Transmitters and Receivers, or by the orientation of the Transmitter in relation to the Saturation Coil, it is possible to vary the depth of penetration into the geologic formation, thus building a detailed characterization profile of the formation at various distances from the casing. The Metallic Transparency may also be used to directionally control the flux transmitted through the casing and into the surrounding geologic formation. This may be accomplished by Magnetic Lensing™

In practicing the invention, it is useful to know the electrical conductivity and permeability of the Well Casing. This allows the optimization of the input frequency, amplitude and power. It will be appreciated that these properties of the Well Casing can be expected to vary as the apparatus of the invention moves along the interior of the casing or production tubing. To eliminate the effects of a varying permeability in a Well Casing, it is preferable to continuously monitor the electrical conductivity and permeability casing or tubing. It is intended that in creating the desired Metallic Transparency, the effect of the Well Casing upon the transmitted and received signals is minimized by the permeability of the Well Casing being reduced to as close to unity as possible while the frequency of the magnetic flux from the Transmitter is varied. When the permeability of the Well Casing is close to unity, total or near total saturation of the Well Casing is achieved. Then, with the frequency magnetic flux held constant, change in the amount of the transparency varies the permeability. This is accomplished by varying the saturation value. The Conductivity of the Well Casing is measured by creating a Metallic Transparency, subjecting this transparent area to varying frequencies and monitoring the received signal. The last transmitted signal detected at the Receiver determines the conductivity of the Well Casing when at total saturation.

There are a plurality of subsystems that may be incorporated into the invention. These include the following:

Full Saturation Magnetic Flux Circuit

Partial Saturation Magnetic Flux Circuit

Transmitter/Receiver System

Nulling System—geometric, electronic, permeability

Automatic Lensing System

Conductivity/Resistivity Measurement System

Wall Thickness Measurement System

Each of these subsystems is incorporated into the preferred embodiment of the Logging Tool. Each will be discussed as part of the subject invention.

### BRIEF DESCRIPTION OF THE DRAWINGS

The accompanying drawings, which are incorporated in and constitute a part of the specification, illustrate preferred embodiments of the invention. These drawing, together with the general description of the invention given above and the detailed description of the preferred embodiments given below, serve to explain the principles of the invention for resistivity measurement of geologic formations from within an installed ferromagnetic casing or similar material.

FIG. 1 illustrates a schematic outline of some of the components utilized in the invention for creating Metallic Transparencies”□ and transmitting and receiving magnetic flux.

FIG. 1A illustrates an alternate schematic outline of some of the components utilized in the invention.

FIG. 2 illustrates an embodiment of the invention whereby an oscillating magnetic flux saturates a Well Casing and a second, higher frequency oscillating flux is transmitted through the Well Casing during the time of saturation.

FIG. 3 illustrates an embodiment of the invention contained within a housing and having the Transmitter and Receiver in a bistatic configuration.

FIG. 3A illustrates the multiple depths of penetration achieved in the near field utilizing multiple Receivers.

FIG. 4A illustrates an embodiment of the Magnetic Transparency Generator component of the invention utilized to engage or couple to the Well Casing with Magnetic Flux.

FIG. 4B illustrates an alternate embodiment incorporating a Magnetic Culminator as part of the Magnetic Transparency Generator.

FIGS. 4C and 4D illustrate alternate embodiments of the invention utilized to couple or saturate the Well Casing incorporating Magnetic Culminators.

FIGS. 5A and 5B illustrate additional alternate embodiments of the invention utilized to couple or saturate the Well Casing.

FIGS. 5C and 5D illustrate a single Magnetic Transparency Generator incorporating both a Transmitter and Receiver configured to conform to the interior dimension of the Casing.

FIG. 5E illustrates a Magnetic Culminator incorporating a Transmitter and Receiver and configured to conform to the interior dimension of the Casing.

FIG. 6A illustrates magnetic coupling between two unlike magnetic poles through a Well Casing

FIG. 6B illustrates the magnetic flux lines within the Well Casing proximate to two like magnetic poles.

FIG. 6C illustrates the magnetic flux lines penetrating the Well Casing proximate to a Magnetic Culminator.

FIG. 7 illustrates an embodiment of the invention comprising a monostatic configuration with the Receiver nested proximate to the Transmitter.

FIG. 8 illustrates another embodiment of the invention comprising a multiple array of Transmitters and Receivers.

FIG. 9 illustrates an embodiment of the invention for placement of a Receiver and Transmitter upon a Magnetic Culminator or Saturation Core of the invention.

FIG. 10 illustrates yet another embodiment of the invention.

FIGS. 10A and 10B illustrate a cross sectional views depicting alternate embodiments of the Saturation Coil shown in FIG. 10.

FIGS. 11, 12, 13A, 13B, 14A and 14B illustrate embodiments of Magnetic Lensing.

FIGS. 15 through 19 illustrate further embodiments of Magnetic Lensing utilized in the invention.

FIG. 20 illustrates the relationship between the frequency of oscillating magnetic flux and depth of penetration into the Well Casing.

FIGS. 21A, 21B, and 21C illustrate the relationship between the Transmitter Current amplitude (FIG. 21A), the Saturation Current amplitude (FIG. 21B), and the Receiver Signal amplitude (FIG. 21C).

FIG. 22 illustrates one embodiment of a bistatic Magnetic Transparency Generator of the present invention

FIG. 23 illustrates the relationship between the flux density (and the change in magnetic field intensity H (ΔH) in amp-turns/meter.

FIG. 24 illustrates the relationship between the Receiver amplitude A_{Rx} and H in amp-turns/meter.

FIG. 25 is a graph of amplitude versus time for a bistatic configured Magnetic Transparency Generator of the present invention coupling with differing Barrier Materials.

FIG. 26 illustrates an embodiment of the method of practicing the invention showing the sequential steps of the method.

FIG. 27 illustrates an experimental apparatus utilized to demonstrate the invention's ability to measure changes in resistivity in media outside a well casing.

FIG. 28 illustrates the experimentally measured changes in resistivity of the media outside the casing, as measured from within the Well Casing.

FIGS. 29, 30 and 31 illustrate other embodiments of the present invention.

FIG. 32 illustrates use of the oscillating Transmitter Signal damping the Saturation Current.

The above general description and the following detailed description are merely illustrative of the subject invention, and additional modes, advantages, and particulars of this invention will be readily suggested to those skilled in the art without departing from the spirit and scope of the invention.

### DETAILED DESCRIPTION OF THE INVENTION

The invention subject of this specification provides a method and apparatus for measuring the electrical resistivity of the geologic formation proximate to a cased well such as a cased hydrocarbon production well. Well Casing (the term used herein to include hydrocarbon production tubing or other ancillary structures such as casing or tubing connectors or couplings) commonly is manufactured of materials that are electrically conductive and magnetically permeable, i.e., “EM Barriers” or “Barrier Materials.” Such materials include ferromagnetic and paramagnetic materials.

The present invention includes the creation of transparencies or windows (“Metallic Transparencies”™) within such Barrier Materials comprising the Well Casing, thereby allowing the passage of oscillating magnetic flux into or through the Well Casing. In simple terms, the invention works in the following steps: (1) a Saturation component (Saturation Inducer or Magnetic Transparency Generator) containing a “Saturation Coil”, preferably wrapped around a highly permeable core (“Saturation Core”). When the Saturation Coil is energized, it acts as an electromagnet. The Saturation Coil creates one or more fields of magnetic flux (“Saturation Current” or “Saturation Flux”) adjacent or near the Well Casing. The Saturation Flux engages with the adjacent Well Casing and creates a partial or full magnetic saturation of the Well Casing proximate to the Saturation Coil. Saturation results in the magnetic permeability of the Well Casing being substantially lowered. When fully saturated, that portion of the Well Casing cannot absorb further magnetic flux, thereby allowing additional flux to pass through the Well Casing. When partially saturated, the Well Casing acquires greater capacity to engage or couple with magnetic flux, especially magnetic flux oscillating at relatively high frequencies. In such a state, that portion of the Well Casing has become “transparent” to magnetic flux. This partially or fully saturated section is known as a “Transparency” or a “Metallic Transparency”. (2) One or more magnetic flux transmitter components (“Transmitters”), each utilizing one or more coils (“Transmitter Coil”) located proximate to a Metallic Transparency, then create one or more fields of additional magnetic flux oscillating at frequencies preferably equal to or greater than the Saturation Flux. This oscillating magnetic flux (“Transmitter Signal,” “Sensing Signal” or “Transmitter Flux”) is engaged with the section of full or partial saturation (having greatly reduced magnetic permeability) allowing the Transmitter Flux (or other oscillating magnetic flux induced by eddy currents within the partially saturated Casing) to pass through the Metallic Transparency of the Well Casing and enter the surrounding geological formation. (3) Electrically conductive media, e.g., water or hydrocarbon, contained within the surrounding formation interact with this oscillating magnetic flux. Through basic electromotive forces, a separate oscillating magnetic flux is induced in the electrically conductive media contained within the formation. (4) The field of this induced magnetic flux extends back to the Well Casing. As in step No. 1 above, the same or similar Saturation Coils create a Transparency near a separate coil (“Receiver Coil”) so that the induced magnetic flux of the geologic formation can be received and measured by this Receiver Coil located inside the Casing. (5) The Receiver component, of which the Receiver Coil is part, converts the induced flux (“Receiver Signal”) into electrical signals (“Receiver Current”) that are filtered and processed in order to determine the electrical resistivity of media located in the geologic formation proximate to the Well Casing. The Receiver Signal is electrically processed to concentrate and magnify the induced oscillating magnetic flux, thereby forming the Receiver Signal. The Transmitter Flux (or Transmitter Signal) is nulled to minimize direct transmission of flux from the Transmitter to the Receiver. The Transmitter Signal is compared to the Received Signal and, using the changes in amplitude and phase, the electrical resistivity of the media in the surrounding geologic formation is determined and displayed. These signals may then be sent to the Output display for further processing, display, and recording. The Output display, power supply, and other ancillary equipment may be located at the well head or surface.

Accordingly, the method and apparatus of the invention includes the capability of generating magnetic flux (“Saturation Flux” or “Saturation Current”) to engage and magnetically saturate a portion of the Well Casing, thereby creating a Magnetic Transparency. The invention also includes the capability to generate and transmit one or more oscillating magnetic flux (“Transmitter Signal” or “Transmitter Flux”) into or through the Metallic Transparency created in the Well Casing. The invention also includes the capability to receive and measure any magnetic flux (“Receiver Signal”) induced in the geologic formation proximate to the Well Casing and penetrating through a Metallic Transparency in the Well Casing.

As will be discussed in greater detail below, the preferred embodiment of the invention will include the ability to generate and send a plurality of Transmitter Flux of differing frequencies, either simultaneously or sequentially. The preferred embodiment will also include the ability to detect and measure Receiver Signal from a plurality of directions. A preferred embodiment will also have the capability to partially saturate one or more portions of the Well Casing in order that one or more frequencies of oscillating magnetic flux may be induced in and focused or directed through partially saturated Well Casing utilizing Magnetic Lensing™.

The preferred embodiment of the invention will also incorporate one or more means to null direct coupling of magnetic flux signal between the Transmitter and Receiver, i.e., the direct transmission of the Transmitter Current to the Receiver Coil. In addition, a preferred embodiment of the invention will include means to accurately measure changes in Casing properties, e.g., conductivity, permeability and thickness.

It will be appreciated that there is a plurality of components or subsystems in the invention.

These include the following:

Full Saturation Magnetic Flux Circuit

Partial Saturation Magnetic Flux Circuit

Transmitter/Receiver System

Nulling System—geometric, electronic, permeability

Automatic Lensing System

Conductivity/Resistivity Measurement System

Wall Thickness Measurement System

All or some of these subsystems may be incorporated into the preferred embodiment of the Logging Tool subject of this invention. Each will be discussed in greater detail below.

1. Full Saturation Magnetic Flux Circuit

The design of the Saturating Magnetic Flux system (hereinafter “Saturation Circuit,” “Saturation Inducer” or “Magnetic Transparency Generator”) allows the reduction of the permeability of the adjacent portion of Casing to near 1 henry/meter. It will be appreciated by those skilled in the technology that the Barrier Material comprising the Well Casing, e.g., carbon steel, may have relative permeabilities in excess of 10,000 at a typical magnetic flux density. A fully saturated portion of the Casing is, however, transparent to the transmission of additional magnetic flux. In this state of full saturation, the fully saturated or transparent portion of the Casing can not absorb further magnetic flux. Therefore, a second and oscillating magnetic flux from the Transmitter of the invention will penetrate through the Transparency of the Casing and into the surrounding geologic formation. It is therefore possible to measure the electrical resistivity of the geological formation proximate to the Transparency created in the Casing. The depth of penetration of the oscillating magnetic flux into the media within the near field of the saturated Casing is proportional to the separation distance between the Transmitter and Receiver of the invention. This is very useful for near Casing measurements. A series of Receivers placed at varying distances from a single Transmitter could establish various depths of measurement directionally into the surrounding geological formation proportional to these separations. It will be noted, however, the as the separation distance “D” between the Transmitter and Receiver(s) is increased, the density of the flux decreases at a rate of 1/D³ and that when the Well Casing is fully saturated, i.e., its relative permeability approaching “unity” or 1, Magnetic Lensing can not be utilized.

2. Partial Saturation Magnetic Flux Circuit

When in a state of partial saturation, the effected portion of the Well Casing can be used for Magnetic Lensing. Simply stated, when partially saturated, the permeability of the Casing is substantially reduced, thereby allowing greater penetration by the oscillating Transmitter Signal, particularly at higher frequencies. However, the relative permeability of the Casing is greater than 1 henry/meter. The partially saturated Casing continues to absorb a significant portion of the Transmitter Signal. Since the Casing is also electrically conductive, eddy currents are generated within the Casing. Oscillating magnetic flux induced by the eddy currents is emitted from the Casing into the geologic formation. The reduced permeability can be utilized to control and concentrate this induced magnetic flux emitted from the partially saturated Casing. The partially saturated Casing therefore acts as a lens to concentrate and direct oscillating magnetic flux transmitted into the surrounding geologic formation. This allows measurement of the electrical resistivity of media within the formation and more distant from the Well Casing than can be achieved by controlling the separation distance between the Transmitter and Receiver.

If a Partially Transparent volume region is created, a separate oscillating EM wave is transmitted into this Partially Transparent volume region, preferably of a higher frequency than the first EM energy source. Eddy currents are generated in the Partially Transparent Material. An oscillating magnetic flux is induced by these eddy currents. At least some portion of the magnetic flux from this induced magnetic field is transmitted out from the Partial Barrier Material. However, the lines of flux are bent or altered as they are emitted out from the surface of the Partially Saturated Material into the surrounding environment. This bending of magnetic flux can be controlled, allowing the lines of magnetic flux to be focused on an Object existing on the opposite side of the Barrier Material from the MTG transmitter. This focusing partially counteracts the normal rapid geometric spreading of magnetic flux. Concentrating the magnetic flux allows distant sensing using much less power. When utilized in this manner, the MTG includes a Magnetic Lens™ capability.

3. Transmitter/Receiver System

There may be a multiplicity of Transmitter/Receiver configurations and orientations.

(a) Transmitter—There may be more than one Transmitter arranged directionally around the Casing. In addition, multiple Transmitter Signals of the same frequency may be bucked with respect to each other to propagate the Transmitter Flux further out into the geologic formation. Also this bucking or interaction among magnetic flux oscillating at the same frequency may be used to direct Transmitter Flux in a controlled manner. A plurality of Transmitters may be configured to achieve a desired Transmitter Signal geometry.

(b) Receiver—There may be a plurality of Receivers used in an evenly or unevenly spaced array. Receiver's may be bucked or used to enhance the signal or establish directionality of received signals.

4. Nulling System

The Receiver system must be nulled with respect to the Transmitter system. This nulling prevents the Receiver system from being overwhelmed by the signals emitted from the Transmitter system. It also minimizes the interference of extraneous electrical signals, i.e., electrical noise. It has been found that a combination of three nulling techniques provides the best results. These three systems are (a) Geometric, (b) Electronic, and (c) Transmitter Signal Absorption by Permeability.

(a) Geometric nulling—A wide combination of geometric nulling systems may be used. The respective design and location of each Transmitter and Receiver may vary in consideration of the placement and design of the other Transmitters or Receivers and in consideration of the location and geometry of the Magnetic Transparency. Therefore, by not wrapping either the Transmitter or Receiver Coils, or both, around the Saturation Inducer of the Casing allows a number of advantages. These are:

1. Mechanical nulling by Receiver or Transmitter placement or rotation with respect to each other, or with respect to the Casing.

2. Directionality by being nearest the Casing side of the Saturation Core, or by rotation of the axis of the Transmitter or the Receiver.

3. Minimizing possible saturation of the Saturation Inducer core that would cause uncontrolled dispersion of Saturation Flux. The dispersed Saturation Flux may achieve only partial saturation of a selected portion of the Well Casing. This may be a desired result. This is exactly opposite the concern cited in U.S. Pat. No. 5,038,107 which does not want to use an AC current on the Saturation Inducer Core that may take the walls or core out of saturation.

4. Since the Transmitter Coil can have an air core, laminated core or smaller inductor core than the Saturation Inducer core, much higher frequencies can be used for the Transmitter Signal. This due to the inductive impedance resulting from the presence of a large metallic Saturation Core. This large Saturation Core drives up the total impedance.

5. Multiple Transmitters, each at different frequencies, may broadcast simultaneously to perform spectroscopy over a large frequency range.

6. Transmitters comprised of differing coil geometry will have different Flux Signal geometry. Therefore varying the design of the Transmitter, e.g., varying the coil length, may also be used to control the portion of the surrounding formation that will be investigated.

7. For applications utilizing full saturation of a portion of the Well Casing, the Transmitters and Receivers must be placed in sufficient proximity to the Metallic Transparency to prevent a large amount of either Transmitter Signal or Receiver Signal being absorbed into the non-saturated high permeability Casing.

8. Multiple Transmitters can be used to “buck” each other, thereby causing the geometry of the Transmitter Flux to be altered. This may achieve a greater penetration into the surrounding formation without utilization of Magnetic Lensing.

9. Multiple Receivers can be either nulled with respect to each other and/or built into an array for improving signal receiving resolution. These techniques may incorporate reversing the direction of at least one of the Transmitter Coils or altering the length of at least one of the Transmitter Coils in relation to the other(s).

(b) Electronic nulling—In this nulling type, it is possible to either null by creating a Receiver Signal 180° out of phase and exactly in reverse amplitude to the Transmitter Signal. Another method is measuring the Receiver Signal attributable to direct coupling of the Transmitter Signal and subtracting this value from all other measured values of Receiver Signals.

(c) Permeability nulling—In this nulling method, a variety of ways may be used to absorb the Transmitter Signal before it reaches the Receiver. This may be accomplished by separating the Transmitter and Receiver by enough high permeability material to absorb the Transmitter Signal before it reaches the Receiver Coil. Another absorption method is to isolate the Transmitter from the Receiver by highly permeable materials such as EM Barriers or by placing the Receiver Coil a large enough distance from the Transmitter such that the Transmitter Signal is absorbed prior to reaching the Receiver Coil.

5. Automatic Lensing System

One variation of the invention utilizes an oscillating Transmitting Current penetrating a Partially Transparent Material. This oscillating current induces eddy currents within the Casing. The eddy currents induced within the Partially Transparent Casing induce a separate oscillating magnetic flux. The field of this oscillating magnetic flux radiates out of the Partially Transparent Casing and into the surrounding geologic formation. This oscillating magnetic flux will generate separate eddy currents within the effected region of the electrically conductive media of the geologic formation.

In this manner, the Casing serves as an antenna for the transmission of oscillating magnetic flux. In addition, the Magnetic Antenna™ capability of the Casing can be utilized to focus or direct the second and separate oscillating magnetic flux in a controlled manner. This feature is termed “Lensing” and the component termed a Magnetic Lens™.

There is a relationship between the amount of power utilized by the Saturation Inducer required to achieve partial saturation and the power utilized by the Transmitter. This relationship can be used to optimize the Magnetic Lensing effect and the strength of the Receiver Signal. When the Transmitter and Receiver are separated in a bistatic configuration, it has been found that optimized signal strength is achieved by increasing the Saturation Current proximate to the Receiver by as much as a factor of four over the power utilized to create the Partial Transparency proximate to the Transmitter. This enhances the Transparency of the Casing proximate to the Receiver. This relationship between the magnetic flux for the Receiver and Transmitter can be derived by known methods. This relationship varies as the casing metal thickness varies and as the permeability and conductivity also vary.

6. Conductivity, Permeability Measurement System

To perform accurate measurements of the media outside the Casing, the properties of electrical conductivity and magnetic permeability.

(a) The conductivity is measured at every new reading in the Casing by analyzing the frequency spectral response over a sufficient range to measure the effects of conductivity on the various frequencies.

(b) The permeability of the casing exhibits a functional relationship to the strength of the saturating coils. Therefore, at each location the power of saturation flux is varied. The frequency of the flux is maintained constant. The change in casing permeability responsive to changes in the saturation flux density is monitored.

7. Wall Thickness Measurement System

Once the conductivity and permeability are determined, an algorithm to calculate the wall thickness has been developed. This algorithm is straightforward and is useful to detecting the variations of wall thickness to corrosive or ablative conditions.

Reference will now be made in detail to the present preferred embodiments of the invention as described in the accompanying drawings.

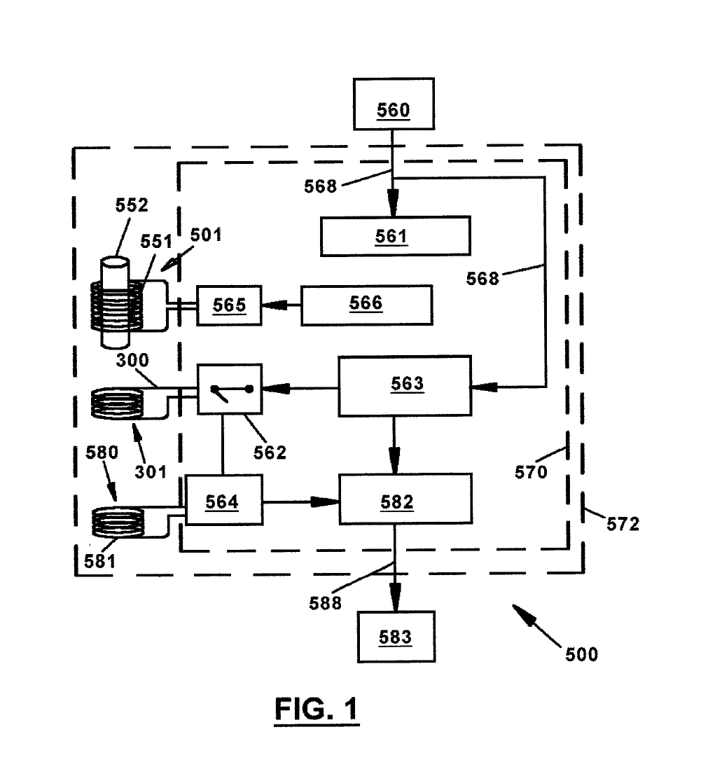

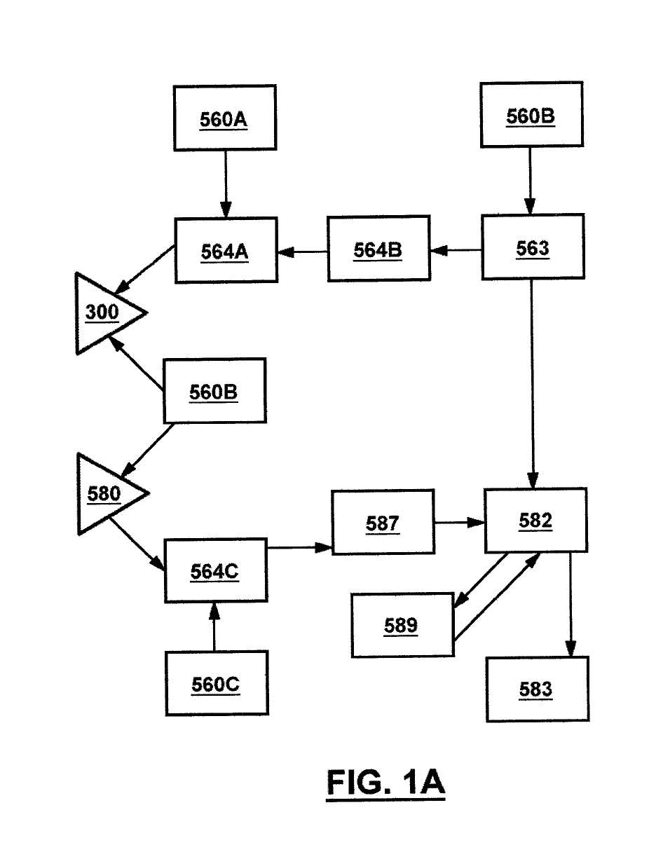

FIG. 1 illustrates schematically one embodiment of the components of the Logging Tool 500 subject of the invention. The components of the Logging Tool that are utilized within the Well Casing are contained within the Logging Tool Housing 572. This Logging Tool includes (a) a Saturation Inducer 501 for creating a Metallic Transparency through the Well Casing and comprising a Saturation Coil 551, (b) a Magnetic Flux Transmitter component 300, comprising the Transmitter Coil 301, a switch 562, and a low noise amplifier (LNA) 564, (c) a Receiver component 580 for the receipt and measurement of magnetic flux penetrating through the Well Casing and comprising a Receiver Coil 581, (d) a frequency generator 563, (e) a pulser 566, (f) one or more capacitors 561 and (g) a nulling device 582. The Saturation Inducer, includes the Saturation Coil 551, Saturation Core or Magnetic Culminator (not shown). The Saturation Inducer 501, Saturation Coil 551, the Transmitter 300, Transmitter Coil 301 and any associated core (not shown), the Receiver 580, including the Receiver Coil 581; and the associated components described above and depicted within the Logging Tool Housing 572, can be lowered into, maneuvered through and raised out of a Well Casing. The Output Display 583, operator controls (not shown) and power source 560 are typically located at the well head or surface and linked to the Logging Tool Housing 572 by means of standard cables and connectors 568 and 588. The operators console or display 583 may also record and display historical trends of resistivity.

FIG. 1A illustrates an alternate embodiment utilizing a high voltage and low voltage power source. The low voltage power source may be utilized for the Transmitter Signal and for the Digital Signal Processor. The high voltage power source may be used with an amplifier for desired amplification of the Transmitter Signal. A DC power supply is preferably used for generating the Transparency Current (Saturation Flux). It may also be found to be advantageous to utilize an analog to digital signal converter. It is envisioned that such a converter, as well as other sub-components, may be contained within the Electronic Component 570 discussed above.

The Saturation Coil 551 is a principle element of the Saturation Inducer 501. It may be utilized in conjunction with one or more Transmitter components, Receiver components, or combinations of both. The Saturation Coil generates a magnetic flux that engages (or couples) with and saturates a portion of the Well Casing. The Transmitter Coil 301 is the principle element of the Transmitter component (“Transmitter”) 300. The Transmitter creates the oscillating magnetic flux that engages with and is transmitted through a magnetically saturated portion of the Well Casing (not shown).

When the Well Casing is saturated with magnetic flux from the Saturation Inducer, one or more additional magnetic flux from the Transmitter 300 may pass through the Well Casing into the surrounding geologic formation. Preferably, the Saturation Coil generates a low frequency or constant magnetic flux. The oscillating magnetic flux of the Transmitter will preferably be at a higher frequency than the frequency of the Saturation Flux. In the preferred embodiment of the invention, the Transmitter has the capability to generate a plurality of separate magnetic flux, each having distinct frequencies.

The Receiver 580 may be combined with a separate Saturation Coil, thereby allowing the Receiver to be placed away from the Transmitter. This has a number of advantages, including facilitating nulling between the Transmitter and Receiver. An embodiment of the Logging Tool of the present invention in which the Transmitter and Receiver are located proximate to separate Saturation Inducers is termed a “bistatic arrangement” or “bistatic configuration.”

The Saturation Coil 551 and Saturation Core 552, the Transmitter Coil 301 and the Receiver Coil 580, are often depicted separately from the other components described above and depicted within the “Electronics Component” 570. For clarity, many of the drawings contained within this specification do not depict the Electronics Component. Further, the drawings may show an illustration of a coil only, but may be variously labeled as a Saturation Inducer, Transmitter or Receiver. It is understood that the other components or sub-components are deemed to be included as necessary. In addition, the components of the invention, including but not limited to the Saturation Coil, Transmitter Coil and Receiver Coil are not placed in physical contact with the Casing.

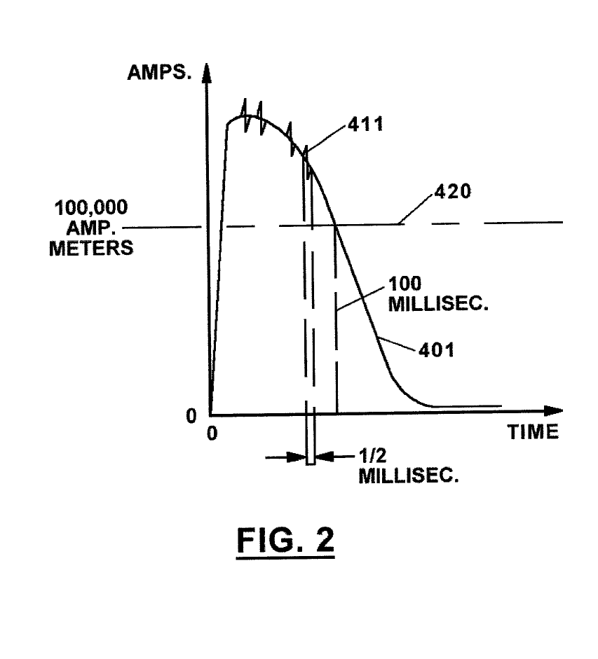

FIG. 2 illustrates a graph of current versus time with respect to the present invention. FIG. 2 illustrates three significant features in practicing the present invention: the level or quantity of Saturation Current (or Saturation Flux) required to achieve saturation through the Casing 420, the higher frequency or Transmitting Signal (or Sensing Signal) 411 and, as compared with the Transmitter Signal, the lower frequency of the actual Saturation Flux 401. The higher frequency Transmitter Signal 411 is imposed on the lower frequency Saturation Flux 401. FIG. 2 illustrates the higher frequency oscillating Transmitter Signal as spikes 411 disposed along a lower frequency oscillating Saturation Flux 401. In one embodiment of the present invention, the Transmitter Signal 411 may be transmitted only during the duration of each cycle of the oscillating Saturation Flux 401 that is above the level 420 required for saturation. Among other advantages, the latter embodiment minimizes energy consumption. In the latter embodiment, it is possible to have multiple transmissions of Transmitter Signal 411 during each phase that the Saturation Flux 401 is above the saturation level 420.

The Saturation Flux 401 may not achieve the level of current (flux density) necessary to saturate the targeted area of the EM barrier material comprising the Casing. However, when partially saturated, the Casing will allow a significantly greater portion of the distinctively higher frequency Transmitter Signals 411 to couple, i.e., penetrate, into the Well Casing to generate eddy currents within an area of partial saturation or, alternatively, be of sufficient magnitude to saturate a portion of the Well Casing when combined with the Saturation Flux and therefore allowing the Transmitter Signal to directly penetrate through the Casing. In another embodiment, the Transparency Current may be generated from at least one permanent magnet, a low frequency AC current or a direct current DC electromagnetic device.

Illustrated schematically as an apparatus in FIG. 1 and conceptually in FIG. 2, the Saturation Coil 551 generates the Transparency Current (Saturation Flux) which in turn creates the Metallic Transparency in the Casing. The Saturation Coil is comprised of conductive material preferably wrapped around a highly permeable core (Saturation Core or Flux Circuit Core) and powered either by DC current or a current oscillating at a low frequency. The Transmitter Signal 411 may be generated by the Transmitter 300, comprised of the coil 301 of conductive material, powered by alternating current, preferably at a controlled frequency, wrapped upon or near the Saturation Coil 551. Preferably, the Transmitter Signal is at a higher frequency than the Transparency Current. It is preferred that the frequency of the Transmitter Signal be at least a multiple of 10 greater than the frequency of the Transparency Current (also termed Saturation Flux). As discussed above, the higher frequency of the Transmitter Signal relative to the Transparency Current allows, for example, 10 wavelengths of the Transmitter Signal to be emitted, and thereby penetrate into the surrounding geologic formation, for inducing an oscillating signal in any electrically conductive media within the formation that may be detected and measured by the Receiver before the Metallic Transparency is closed by the Transparency Flux falling below the level 420 required to achieve saturation.

In FIG. 2, the high frequency Transmitter Signal 411 is illustrated being pulsed at less than 0.5 millisecond rates. If the lower frequency Transparency Current 401, generated by the Saturation Coil 551, is pulsed or activated “on” for 10 milliseconds 430, there is sufficient time for twenty Transmitter Signals (e.g., with a wavelength of only 0.5 millisecond) to be emitted through the saturated Casing and into the surrounding geologic formation. As explained in the preceding paragraph, these 20 oscillating signals 411 emitted during the “on” pulse of the Transparency Current 401 may induce oscillating eddy currents that may be detected and measured by the Receiver located within the Casing and comprising part of the Logging Tool subject of this invention.

For most applications, a power source of 300 watts or less is sufficient to create the Transmitter Signal and Transparency Current. For thicker material, strong pulses and signals may be generated by utilizing the charge storing capacitors 561. The capacitors 561 are slowly charged then quickly discharged through a switch contact and then through the low impedance large coil 551. At the same time, the higher frequency small signal coil 300 is pulsed.

With reference to the preceding abbreviated outline of the invention and FIG. 1, the invention comprises the following steps and utilizes the referenced components and sub-components: (1) the Saturation Coil 551, when energized, acts as an electromagnet. The Saturation Coil creates one or more fields of magnetic flux adjacent or near the Well Casing (not shown). The Saturation Coil creates a partial or full magnetic saturation within at least a portion of the Well Casing immediately proximate to the Saturation Coil 551. Saturation results in the magnetic permeability of the Well Casing being substantially lowered. When fully saturated, that portion of the Well Casing cannot absorb further magnetic flux, thereby allowing additional flux to pass through that portion of the well casing. In such a state, that portion of the Well Casing has become Metallically Transparent to magnetic flux. In order to create a full Metallic Transparency, the full saturation must extend through the thickness of the Casing. (2) The Transmitter 300 then creates one or more fields of additional magnetic flux having frequencies preferably equal to or greater than the saturation flux. The second field of magnetic flux is engaged with the section of full or partial saturation (having greatly reduced magnetic permeability) allowing the Transmitter flux to pass through the Transparency of the Well Casing and enter the surrounding geologic formation. (3) Media in the surrounding formation that contains electrically conductive properties interact with the oscillating magnetic flux created by the Transmitter 300. Through basic electromotive forces, a separate oscillating magnetic flux is induced in the electrically conductive media. (4) The induced magnetic flux travels back to the Well Casing. As in step No. 1 above, the same or similar Saturation Coils 551 create a Transparency near the Receiver 580 so that the induced magnetic flux can be detected and measured through the Casing. (5) The Receiver converts the induced flux into electronic signals that are filtered and processed in order to determine the resistivity of media located outside the Casing. The received signal is processed using various electronic components (which may be located within the Electronic Component 570) to concentrate and magnify the reacted oscillating magnetic signal. The invention may contain means 582 to electronically null the Transmitter Flux to minimize direct transmission of flux from the Transmitter 300 to the Receiver 580 and to minimize the interference of electronic noise. The transmitted signal is compared to the received signal and, using the changes in amplitude and phase, the resistivity is determined and displayed. These signals are then sent to the Output Display 583 for further processing, display, and recording.

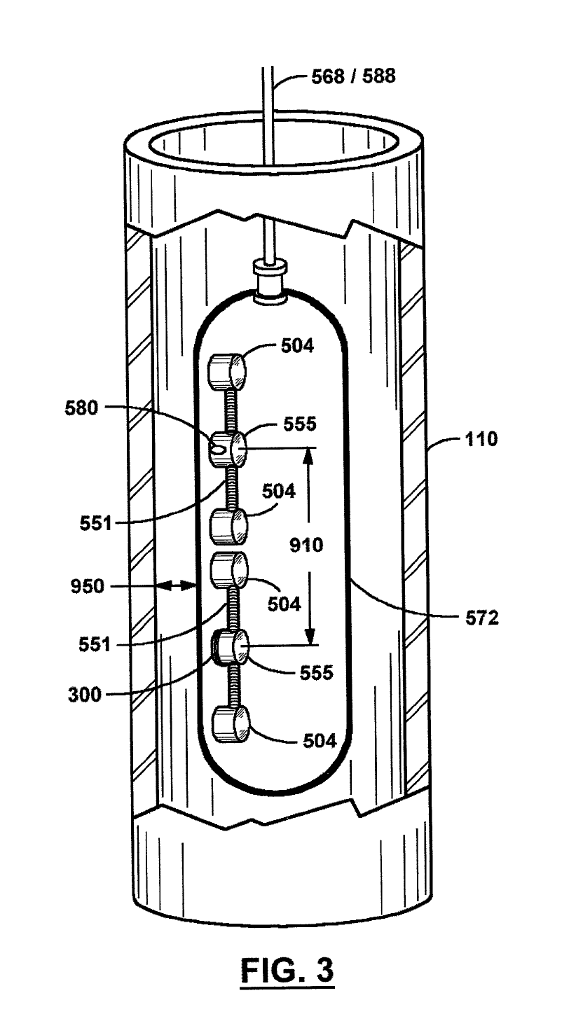

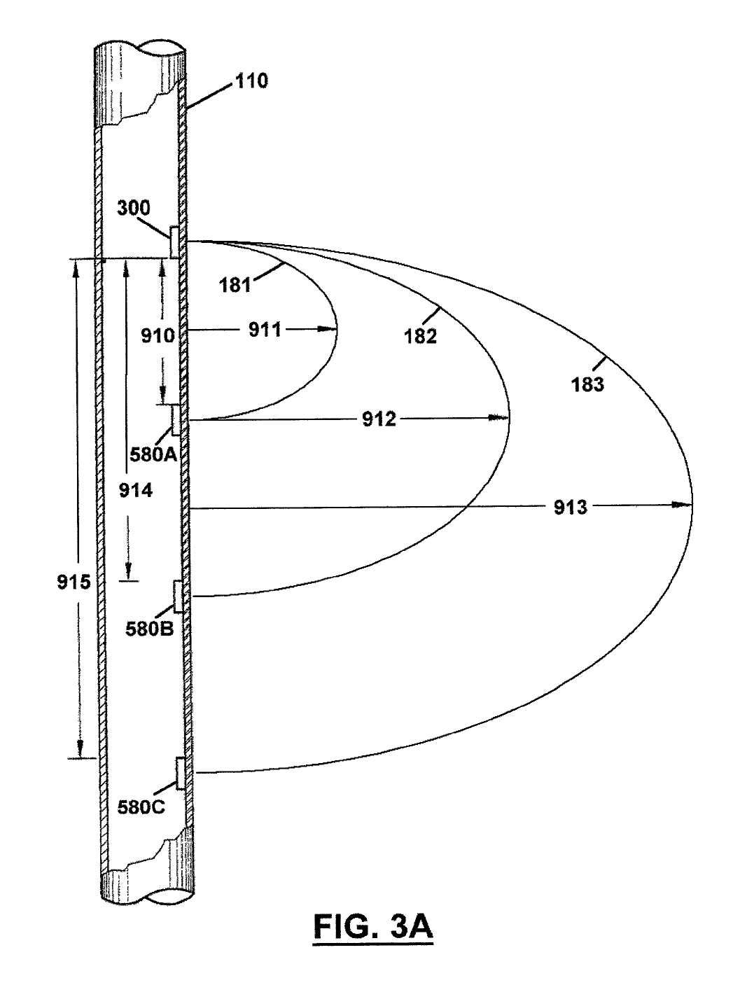

FIG. 3 illustrates the Logging Tool 500 containing components of the invention installed within a housing 572 configured to fit within and be lowered into a Well Casing 110. The outside diameter of the logging apparatus of the present invention (“Logging Tool”) allows the Logging Tool 500 to be lowered and raised along the axial path of the Well Casing 110. It should be noted that a Logging Tool may be configured also for utilization within the production tubing installed inside a Well Casing. The standard communication 588 and power cables 568 that are used currently for production systems provide the linkage from the Logging Tool components located within the Housing to the surface controls. The Logging Tool needs no more power or special communications than is already available by means of existing logging tool systems.

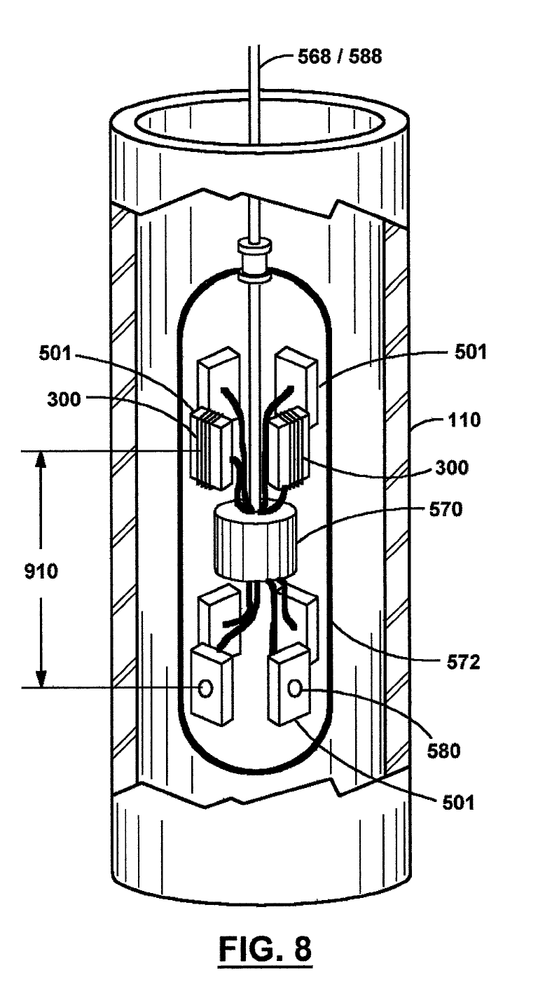

In other embodiments, the power for operation of the Logging Tool may be provided by batteries (not shown) within the Housing 572. In yet other embodiments, the Logging Tool can be configured with a plurality of components. For example, multiple Receivers could be utilized with one or more Transmitters. In still other embodiments, the Logging Tool components may be configured in series or parallel. Other embodiments may utilize a plurality of components to achieve transparencies, magnetic flux transmission and reception in multiple directions within the same vertical depth. The Tool may also be configured with a plurality of Housing components interconnected and containing multiple configurations of components, i.e., Transmitters, Receivers or Electronic components. This may facilitate measurements being made in multiple directions or to make multiple measurements for increased accuracy, including measurements with multiple frequency or different Lensing or Transparency configurations. FIG. 8 illustrates an example of this configuration of multiple Transmitters, etc.

In the preferred embodiment of the invention, the Housing 572 consists of a non-permeable material such as stainless steel. It may also be manufactured of material that is also not electrically conductive, such as a ceramic or glass fiber reinforced material, e.g., a fiberglass structure. Again, it should be noted that FIGS. 3 and 8 illustrates a bistatic configuration of the invention.

FIG. 3 shows a separation distance “D” 910 between the Transmitter 300 and Receiver 580. FIG. 3A illustrates another embodiment of this configuration, but with multiple Receivers 580A, 580B and 580C built into an array for improving signal resolution or detection of signals from electrically conductive media within the formation and at varying distances from the Casing. The Transmitter 300 and Receiver 580A, 580B and 580C may each be incorporated into or used in proximity to separate Saturation Inducers (not shown). A single Transmitter Signal can be used to detect electrically conductive media at varying distances by locating separate Receivers at varying distances from the Transmitter.

Within the near field, the distance of preferred signal reception will be a function of the distance “D” of the Receiver from the Transmitter, e.g., 910 or 914 or 915. Lines 181,182 and 183 represent 3 flux lines of the same Transmitter Signal. The Receiver 580A, located distance 910 from the Transmitter, will receive signals from electrically conductive media located along the arc of flux line 181. The most distant signal will be detected from an object at a distance 911 from the Casing. Receiver 580C, located distance 915 from the Transmitter 300, will receive signals from electrically conductive media located along line 183. The most distant signal will be at a distance 913 from the Well Casing. The geometry of the configuration results in the most distant signal for any Transmitter/Receiver combination will be at a point between the Transmitter and Receiver. The greatest distance capacity will not exist directly in front of the Transmitter. It will be appreciated that the power required to generate a signal detectable by 580C will be significantly greater than the power to create a signal detectable by 580A.

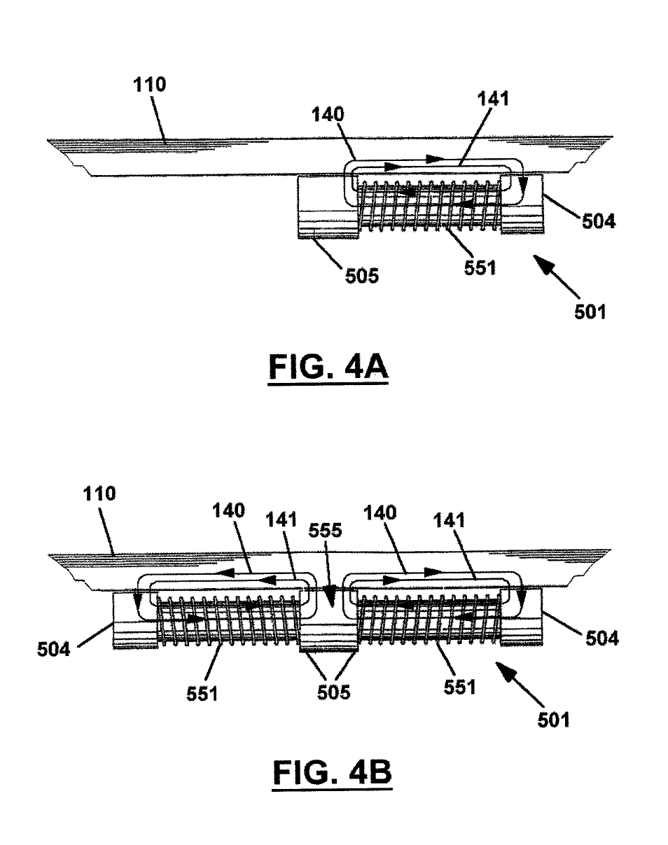

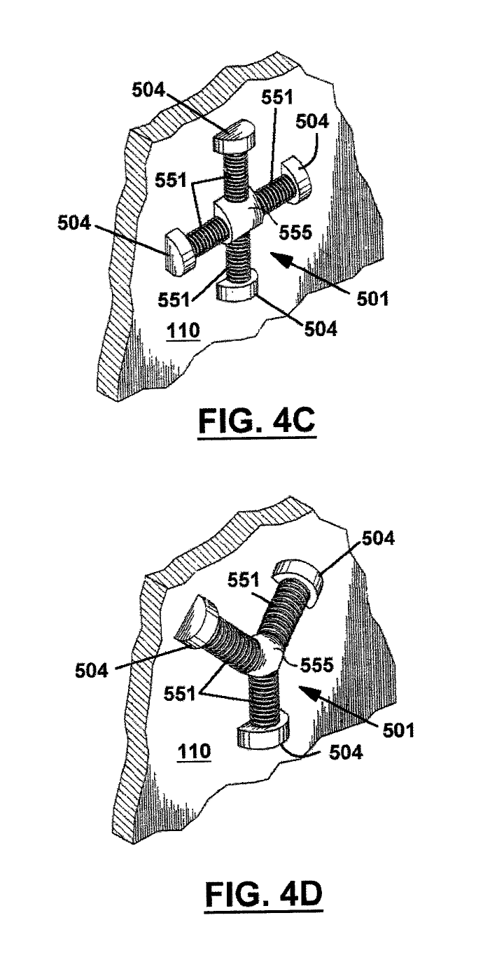

FIG. 4A is a single axis Magnetic Transparency Generator (Saturation Inducer) device 501 that may be utilized for the Logging Tool subject of this invention. The one-dimensional Magnetic Transparency Generator 501 has magnetic flux lines 140 and 141, pole orientations North 505 and South 504. It is of course recognized that the pole orientations may be switched without a change in the subject invention. This Saturation Flux may engage to the Well Casing 110. It is also noted that most, if not all of the magnetic flux will shift to the side of the Inducer adjacent to the Well Casing. This is attributable to the high magnetic permeability of the Well Casing, i.e., ability to absorb magnetic flux.

FIG. 4B is another embodiment of a single axis Saturation Inducer 500 but having two cores 551 and south poles 504. The two north poles 505 are combined into a Magnetic Culminator 555. It will be appreciated by persons skilled in the technology that the Culminator must be of sufficient magnetic permeability and mass in order that it not be saturated by the Saturation Flux or by a combination of the Saturation Flux and Transmitter Flux.

FIG. 4C is a two-axial Magnetic Transparency Generator device 500 utilizing a Magnetic Culminator 555. The two-axial cross-flux Magnetic Transparency Generator is adjacent to the Well Casing 110. The four like poles 504 are connected to four separate cores 551. The opposing magnetic poles are contained within the mass of the Magnetic Culminator 555. FIG. 4D is a three axis Magnetic Transparency Generator device 500 also incorporating a Magnetic Culminator. The three axis device is adjacent to the Well Casing 110.

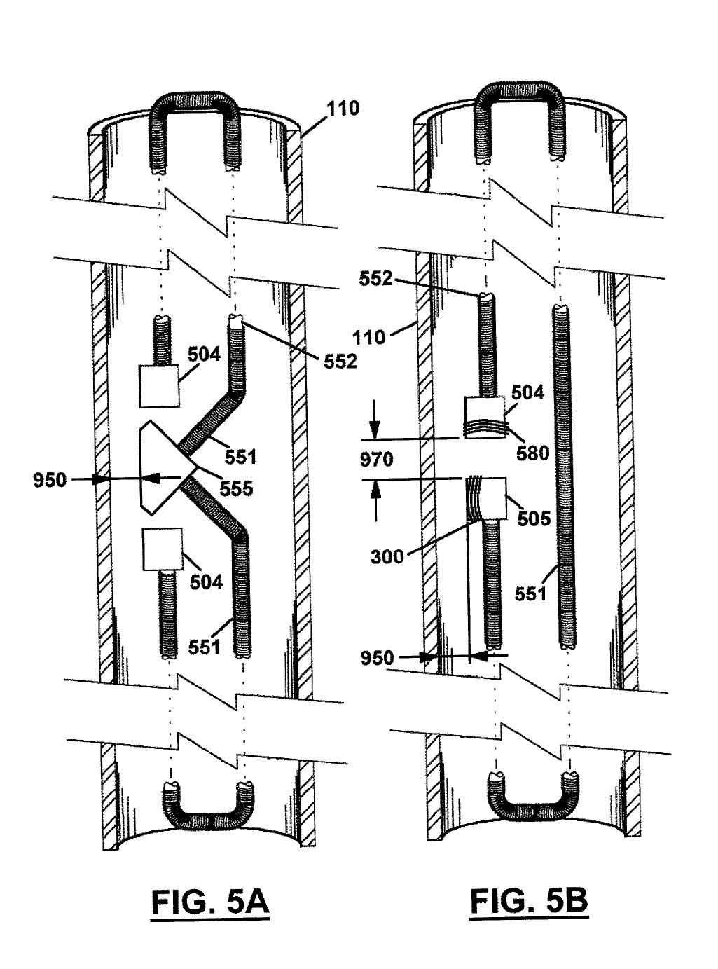

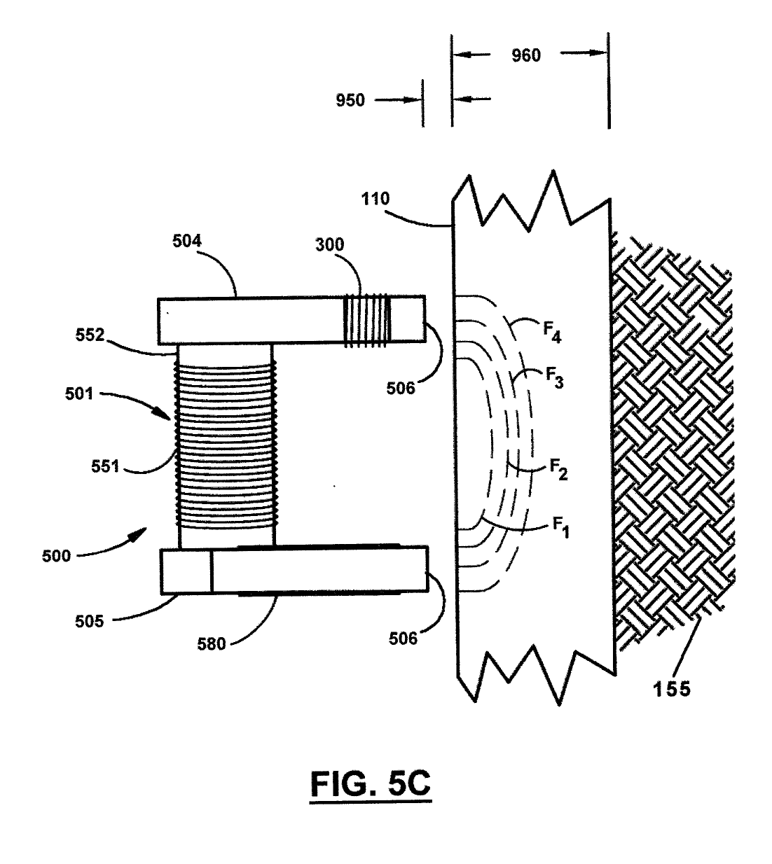

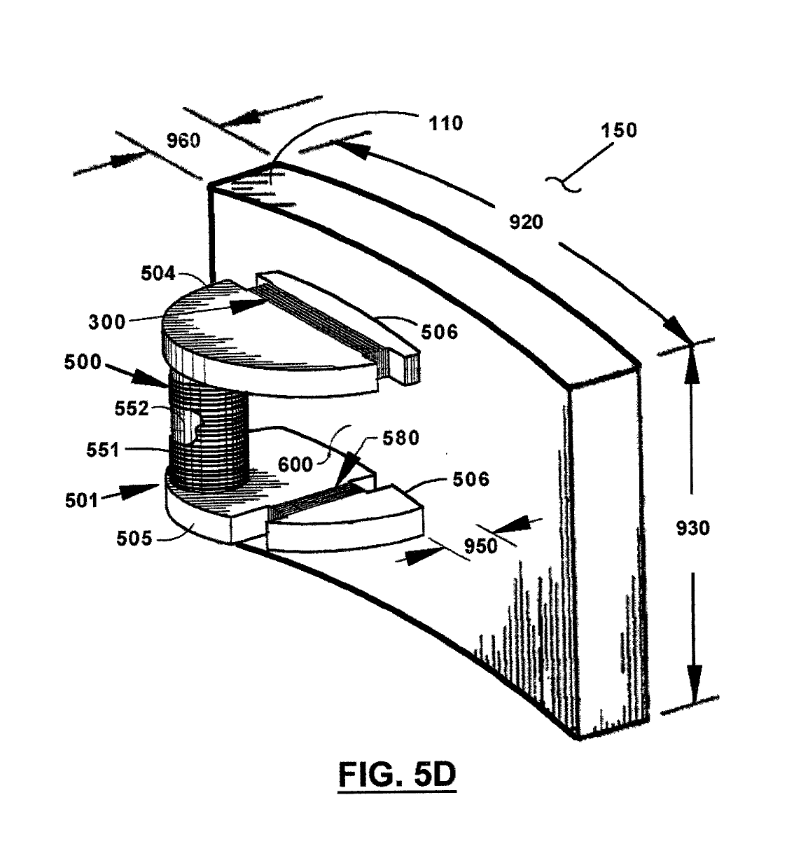

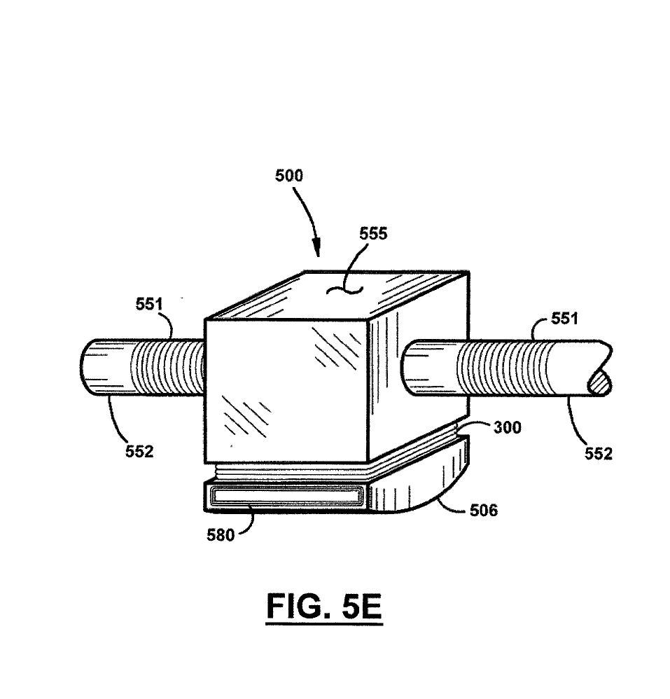

FIG. 5A and FIG. 5B illustrate Magnetic Transparency Generators comprises of elongated coils wrapped upon highly permeable cores. As with the Magnetic Culminators, the Saturation Cores must not become saturated by the Transparency Flux. The illustrated configuration of the Saturation Circuit is advantageous for use in the present invention since it allows a strong Saturation Flux to be generated in the relatively narrow space of a Well Casing. In regard to FIG. 5A, the complete length of the Saturation Coils 551 contribute to the magnetic flux generated between the Magnetic Culminator 555 and each South pole 504. Similarly, for the configuration illustrated in FIG. 5B, the complete length of the Saturation Coil 551 contributes to the quantity of magnetic flux (flux density) existing between the South pole 504 and North pole 505. This is important since the length of the coils can greatly exceed the space 970 between the magnetic poles. It has been found that electromagnetic coils wrapped on a core for at least a distance of up to 100 diameters of the core diameter still contribute to the pole strength and the amount of magnetic flux existing between the two magnetic poles.

FIGS. 5C and 5D illustrate Saturation Inducers 501 incorporating both the Transmitter 300 and Receiver. This configuration is termed a monstatic configuration. The illustrated Saturation Inducer is configured to create a single Transparency in the Casing 110. The Saturation Coil 551, Transmitter 300 and Receiver 580 are each nulled 90° to the other. FIG. 5C illustrates the Saturation Flux lines F1 through F4 engaged with the Casing. The ends 506 of each pole 504 and 505 are curved to conform to the interior curvature of the Casing 110. The gap 950 between the Logging Tool 500 prevents an electric current between the Logging Tool and the Casing. FIG. 5D provides another illustration of the Logging Tool. The surrounding geologic formation is also illustrated 150.

FIG. 5E illustrates a Magnetic Culminator 555 that incorporates a Transmitter 300 and a Receiver 580. One face 506 of the Magnetic Culminator is designed to conform to the concave interior surface of the Casing. In the preferred embodiment, the axis of the Transmitter Coil 300 is orthogonal to the axis of the Receiver Coil 580 and that both are orthogonal to the axis of the Saturation Coil 551A and 551B.

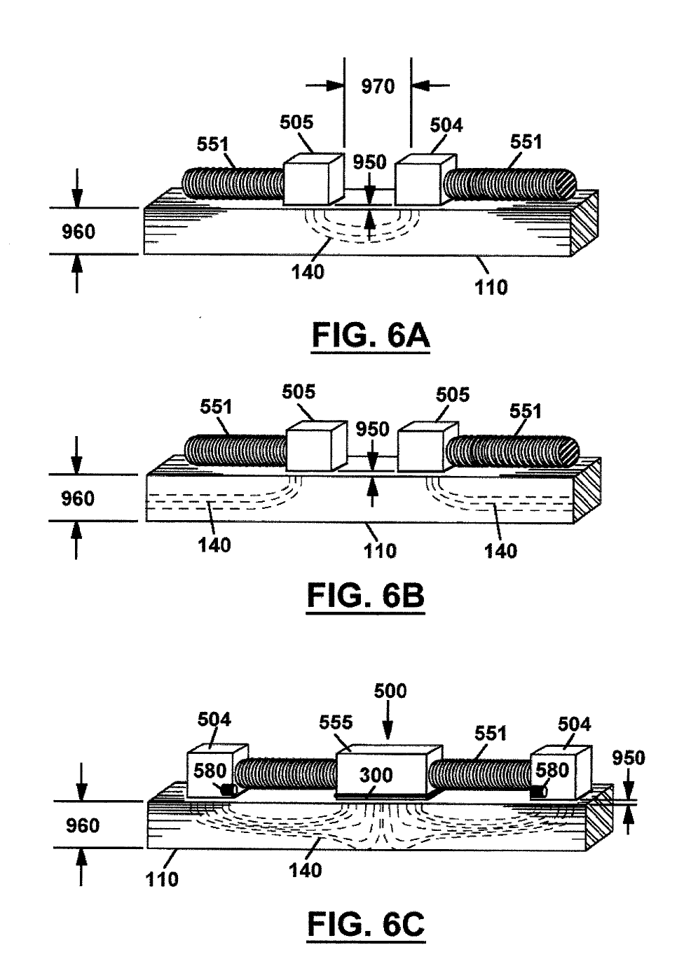

FIGS. 6A, 6B and 6C show the geometry of the Saturation Flux 140 engaging the Casing 110. FIG. 6C illustrates a configuration with the Transmitter 300, wound around the Magnetic Culminator 555, is more centrally located in relation to the magnetic flux lines engaging or penetrating the greatest distance into the depth 975 of the Casing 110. In FIG. 6B, two opposing South poles are brought together or in close proximity between two North poles. The magnetic flux field lines emitted from the opposing South poles push the flux field out into the Well Casing 110. However a large unsaturated volume region remains.

FIG. 6C shows the use of the Magnetic Culminator 555 containing two like poles 505. It has already been demonstrated that multiple like poles may be combined into a single Magnetic Culminator. Note that the magnetic flux lines bulge, facilitating the saturation of the thickness 960 of the Casing. This results in the location being well suited for placement of a Transmitter 300. Note that the Logging Tool is not in contact with the Well Casing as shown by the gap 950.

It has also been found that enhanced Magnetic Coupling, i.e., penetration of the Well Casing 110 by the Transparency Current without saturation, is achieved utilizing this Saturation Inducer configuration 500. In this case, coupling allows more energy to be transferred to the Casing 110 from the Saturation Inducer 500.

Moreover, it is the goal of the invention to concentrate the magnetic flux energy of the Transparency Current into a minimal volume region. For the configuration illustrated in FIG. 6A, the spacing between the two unlike poles 970, however, is limited by the thickness of the casing 960. Therefore, if the material is “T” inches thick 960, to saturate all the way through the Casing the spacing 970 between the two poles 504 and 505 must be at least “T” inches apart in the simple configuration shown in FIG. 6A. However by “bucking” the poles, the same “T” inches depth of penetration may be achieved but with less than “T” inches separation between like poles. The benefit of minimizing the distances between the poles is that less energy, i.e., amp turns, are required for partial or full saturation of the subtended Casing. If very long distances are to be measured outside and away from the Casing, then it is advantageous if the Transmitter and Receiver are positioned in a bistatic array, i.e., each located within or in conjunction with separate Magnetic Transparency Generators. This facilitates nulling and reduces the energy requirements.

As the number, diameter and length of the coils increases, the mass and the permeability of the Magnetic Culminator must also increase in order to achieve the concentration of magnetic flux energy of the Transparency Current. It will also be appreciated that neither the Magnetic Culminator nor any other component of the Magnetic Flux Generator is in electrical contact with the Casing.

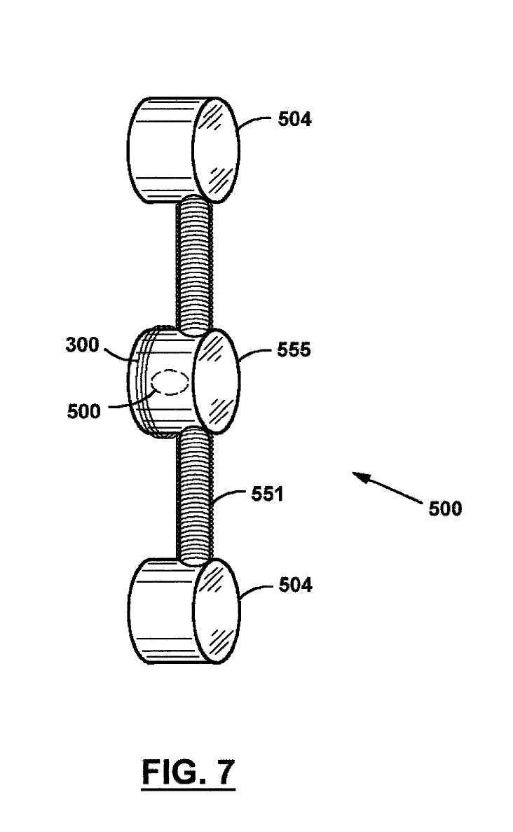

It will be appreciated that utilization of the bistatic configuration, illustrated in FIG. 3 and FIG. 3A to measure the thickness of the Casing 110, will consist of the measured average of the casing thickness over the distance 910 (or 914 or 915 as applicable). However, it is possible to obtain measurement by nesting the nulled Receiver inside the Transmitter Coil 300. This configuration is shown in FIG. 7. In FIG. 7, the area of wall thickness measurement is a function of the Transmitter Coil diameter. For the above reasons, FIG. 7 illustrates a preferred embodiment of the invention, allowing compact size, decreased mass and energy consumption, and enhanced accuracy.

FIG. 8 illustrates another bistatic configuration with multiple, simultaneous direction measurement capability.

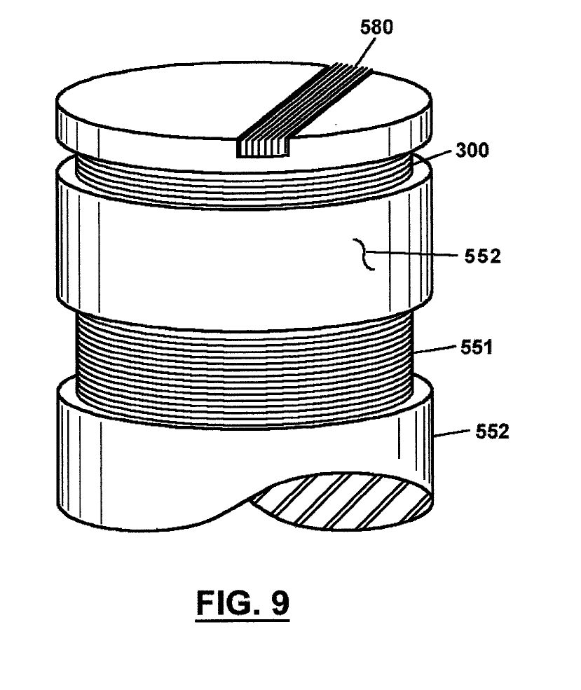

FIG. 9 illustrates an embodiment of the invention wherein the Saturation Coil 551 and the Transmitter Coil 300 are separately wrapped around the same Flux Circuit Core 552. The Flux Circuit Core is a simple cylindrical shape with both the Saturation Coil 551 and the Transmitter Coil wrapped in parallel around the axis of the Flux Circuit Core 515. Since the Transparency Coil 551 and Transmitter Coil 300 have the same diameter, they will have the same magnetic moment (amp turns/meter)

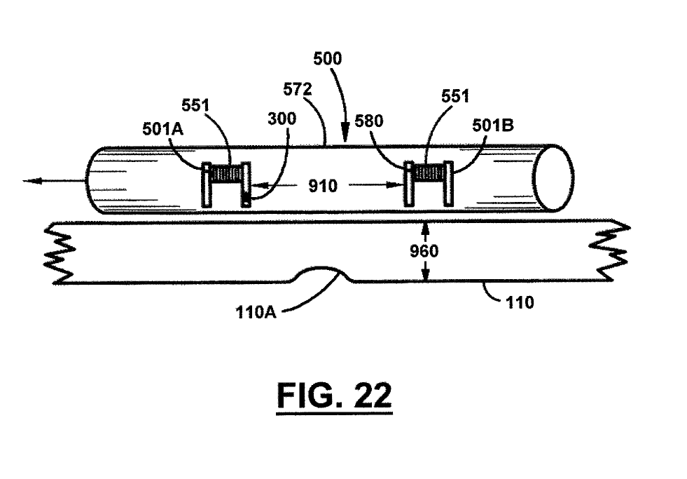

For the reasons stated previously, it will be appreciated that the Transparency Current can not be allowed to saturate the Flux Circuit Core 552. Further, the Transmitter Current will generate eddy currents in the Flux Circuit Core. Further it will be appreciated by persons skilled in the art that the greatest saturation will occur along the circumference of the Flux Circuit Core in as much as the permeability of the near saturated or partially saturated Flux Circuit Core will be lowest at the circumference, i.e., edge of the cylinder. Since the permeability of the Barrier Material will approach the permeability of air, the angle of refraction of the magnetic flux (not shown) induced by the eddy current within the Flux Circuit Core will increase from the perpendicular. It will be further appreciated that this configuration has created or utilized Magnetic Lensing capacity within the Magnetic Transparency Generator. This configuration also is a preferred embodiment due to its compact size, energy efficiency, accuracy of measurement and ability to utilize Magnetic Lensing. FIG. 22 also illustrates the placement of a Receiver Coil 580 nulled to the Transmitter Coil 300.

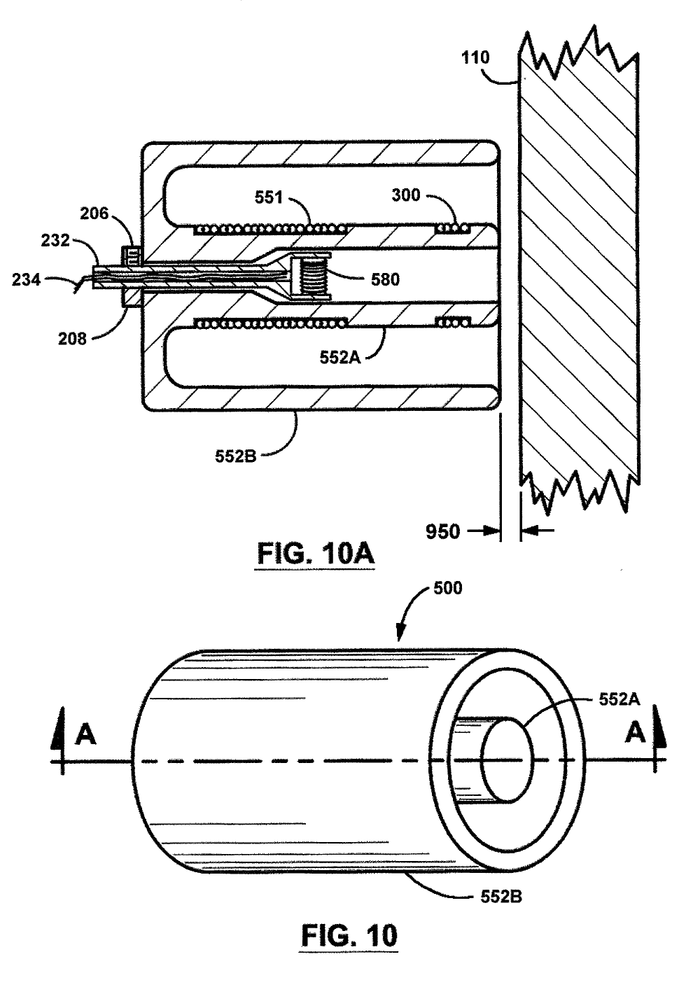

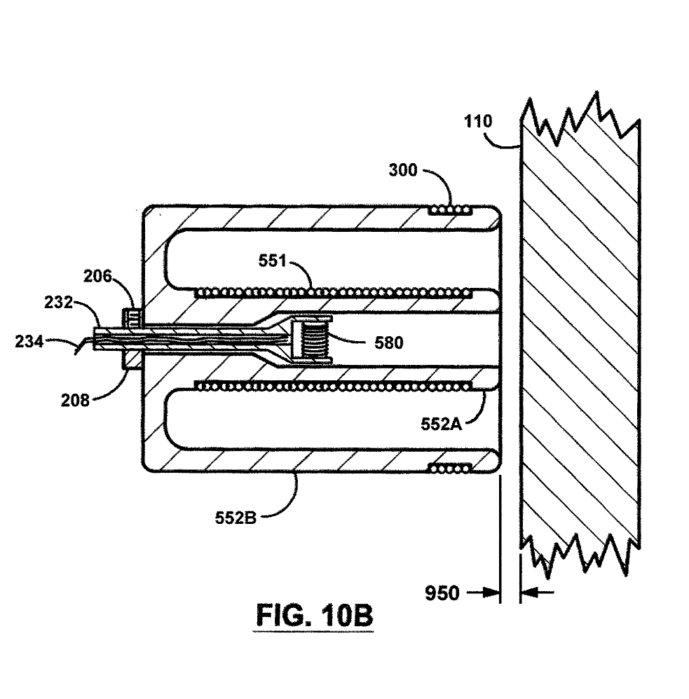

FIG. 10 illustrates another embodiment of Logging Tool 500 used in conjunction with a single Magnetic Transparency Generator to create the necessary Metallic Transparency to practice the present invention. The Logging Tool 500 comprises an outer cylindrical portion 202 and an inner cylindrical portion 204. The Transmitter, Receiver and Saturation Coils are disposed on, in or around the outer cylindrical portion 552B and the inner cylindrical portion 552A.

FIG. 10A illustrates an embodiment of a Logging Tool 500 used to generate a Transparency with respect to a material 110 for practicing the present invention as could be adapted in FIG. 10. A Transmitter Coil 300 is disposed at the remote end of the outside diameter of the inner cylindrical portion 552B of the Saturation Core. A Saturation Coil 551 is disposed at the inner end of the outside diameter of the inner cylindrical portion 552A of the Saturation Core. A Receiver Coil 580 is disposed within the inside diameter of the inner cylindrical portion 552A of the Core. The Receiver Coil 580 can be located at different positions using a shaft 232 which telescopes within the inside diameter of the inner cylindrical portion 552A of the Saturation Core. The telescoping shaft 232 can also rotate using a set-screw adjustment 206 and a set screw housing 208. Also, wiring 234 can be channeled through the shaft 232.

FIG. 10B illustrates another embodiment of a Logging Tool 500 used for practicing the present invention as could be adapted in FIG. 10. A Transmitter Coil 300 is disposed at the remote end of the outside diameter of the outer cylindrical portion 552B of the Saturation Core. A Saturation Coil 551 is disposed along the outside diameter of the inner cylindrical portion 552A of the Saturation Core. A Receiver Coil 580 is disposed within the inside diameter of the inner cylindrical portion 552A of the Saturation Core. The Receiver Coil 580 can be located at different positions using a shaft 232 which telescopes within the inside diameter of the inner cylindrical portion 204. The telescoping shaft 232 can also rotate using a set-screw adjustment 206 and a set screw housing 208. Also, wiring 234 can be channeled through the shaft 232.

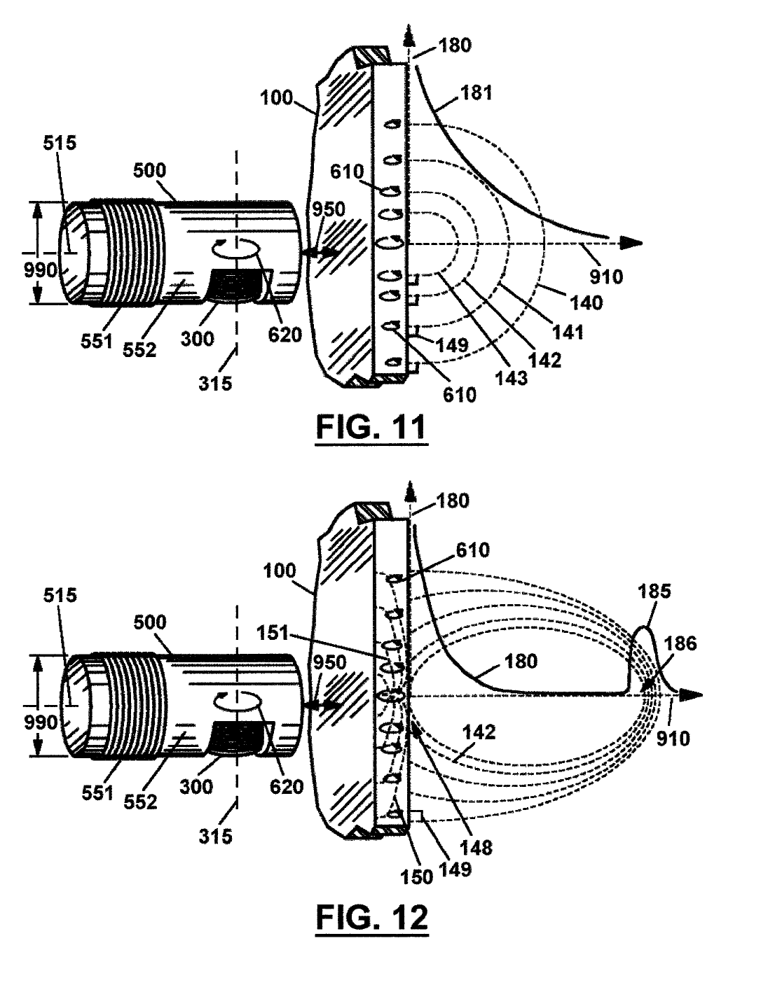

As shown in FIG. 11 a Saturation Core 552 is axially wrapped with insulated wire, forming a Saturation Coil 551, to create a powerful low frequency or D.C. magnetic field along the longitudinal 515 axis of the Core 552. The Saturation Core is comprised of a ferromagnetic metal or other highly magnetically permeable material used so that the magnetic flux created by the Saturation Coil does not disperse. “Low” frequency is defined by relationship to the frequency of the Transmitter Current wavelengths needed to make a measurement, e.g., if ten wavelengths are needed for the measurement, then the low frequency must be a least 1/10 of the frequency of the Transmitter Current.

Also in FIG. 12, one embodiment of the invention shows a separate Transmitter 300 wrapped such that the eddy currents 620 generated in the core have an axis 315 perpendicular to the long axis 515 of the core 552. This core is then placed in some gap or distance 950 to the Casing 110 This EM Barrier can be made completely transparent for the Transmitter or, alternatively, an antenna or lens utilizing Partial Transparency. The optimum size of the gap 950 between the core 552 and the Casing 110 is proportional to the magnetic moment of the transmitter/core diameter 990 and any lensing derived from the surface of the core 552 by the Transmitter Current being focused by the Transparency Current.

As previously mentioned, when a gap is present, e.g., insulation causing the space between the Saturation Core 552 and Well Casing 110, the wrapping of the Transmitter 300 on the Core 552 utilizes this gap to create the Magnetic Lensing effect at the surface of the Saturation Core, analogous to the Lensing that can be created at the Well Casing surface using partial saturation. This Magnetic Lensing counteracts the decreasing Transmitter Flux, i.e., the decrease in the Transmitter Flux density as the distance from the Transmitter or Saturation Core increases. The rate of this decrease in Transmitter Flux density is the inverse cube of the gap distance between the Saturation Core interface to the Well Casing. This is illustrated by the relationship of magnetic flux intensity decreasing to zero as the inverse cubed of the distance (D) 910 away from the surface, i.e., Intensity Plot=1/D³. Note that in this example, the Transmitter is located on the Saturation Core. It will be appreciated by persons skilled in the art that the Saturation Core concentrates the Transmitter Flux. It will be appreciated that in the preferred embodiment of the invention, a ferromagnetic material or other electrically conductive and magnetically permeable material (“EM Barrier”) is used for the Magnetic Lensing component.

As illustrated in FIG. 11, there is less Lensing in the gap 950 and on the Casing 110 due to the limited penetration of the Transmitter Flux into the unsaturated Core 552. However, the eddy current generated within the casing by the low frequency Transmitter Flux will also induce oscillating magnetic flux. The Transmitter 300 induced eddy currents 610 in the Casing 110 are shown in FIG. 11. The resulting magnetic flux lines 140, 141, 142 and 143 generated from these electrical eddy currents inside the Casing are shown in FIG. 11 intersecting the Casing surface perpendicularly 149.

FIG. 12 depicts the change caused by the activation of the Saturating coil 551. In this embodiment, as shown in FIG. 11 and FIG. 12, the Transmitter 300 is a separate coil from the saturation coil 551. It is also assumed that the Transparency Flux current is either D.C. or has frequency much less than the oscillating Transmitter Flux. The magnetic flux field lines 150 of this constant or low frequency magnetic Transparency Current are shown within the Casing 110. This constant or low frequency magnetic flux lowers the permeability of the Well Casing. The region of greatest influence of the magnetic flux of the Saturation Core 552 is shown nearest the surface of the Well Casing 110 and decreasing into the Casing. As the permeability of the Casing is reduced by the increasing magnetic saturation from the Transparency Flux, the Transmitter flux lines begin to change their surface angle of impingement away from the perpendicular. It can be readily appreciated that the impingement angle 148 at the surface will be the limited to the flux angle that would exist if the Casing was not present. This limit is approached as the permeability of the Casing approaches unity with the permeability of the matter or media in the gap or space, e.g., air, adjacent to the Casing. This changed impingement angle is shown in FIG. 12 near the region of the Core's greatest influence in having reduced the permeability on the Casing. Further away radially from the Saturation Core, the magnetic flux lines again impinge perpendicularly to the Well Casing surface 149.

Also shown in FIG. 12 is a plot 180 of the resulting flux intensity variation along the centerline 910. This shows an intensity spike 185 due to the concentration of the field at some fixed distance away from the Casing surface. This flux field concentration is the same effect as would be obtained from an optical “lens” and is termed “Magnetic Lens” effect. The distance away from the EM Barrier plate at which these flux lines are concentrated is called the “Magnetic Focal Length.” The place these flux lines are focused is called the “Magnetic Focal Point” 186. This Focal Point may be moved toward or away from the Barrier Material 100 by reducing or increasing the magnetic moment of the Transmitter and the Transparency Coil or the geometry of the magnetic fields in the metal plate.

It will be appreciated that there is another embodiment wherein the Transmitter Signal coil is superimposed electronically on the coupling Transparency coil. There are separate advantages to this configuration and the configurations shown in FIGS. 11, 12, etc. When limited by physical and power constraints, it is advantageous to utilize the configuration wherein the saturation coils and transmitter coils are physically separated but magnetically coupled. Both configurations are claimed as part of this invention.

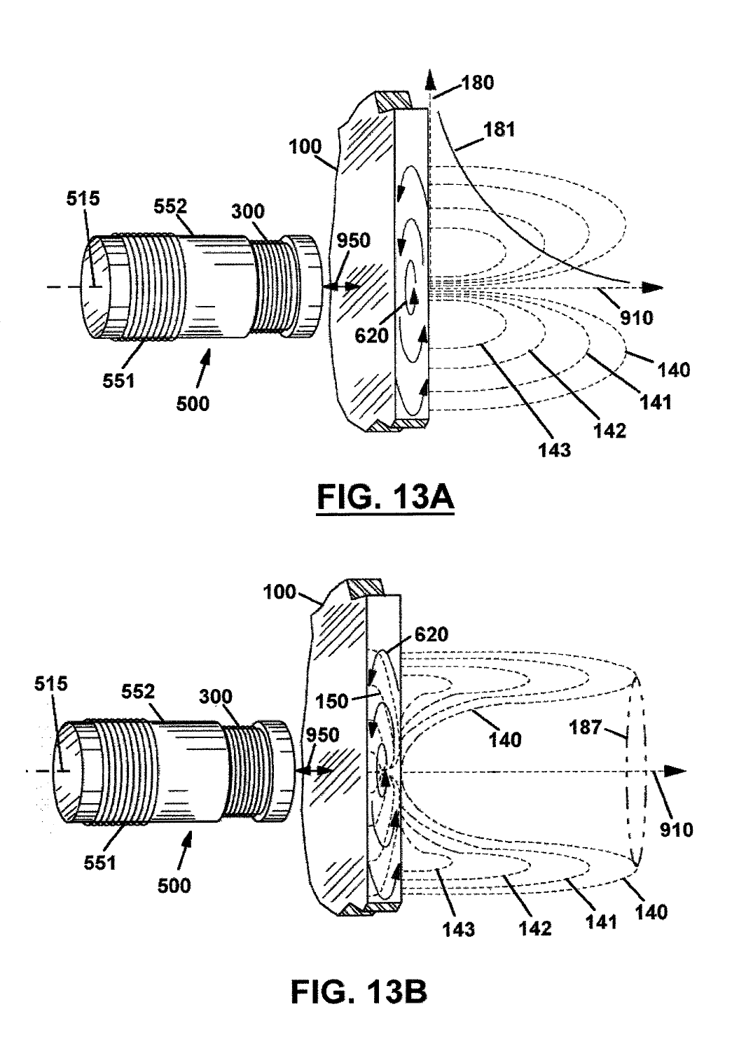

In FIG. 13A, the Transmitter Coil 300 is rotated to be approximately parallel to the Casing 110, ignoring temporarily that the Well Casing surface is necessarily curved in forming the cylindrical shape. The Transmitter induced eddy currents 620 generate the magnetic flux field having a geometry illustrated by field lines 140-143. Note the density of the magnetic flux field lines along line 910 as the flux field emerges from the partially saturated Casing surface 110. Supplemented on the FIG. 13A is the plot 181 of the decrease in magnetic field intensity 180 as the distance from the surface 910 increases. The magnetic flux field intensity 180 decreases to zero along the plotted line 181. This illustrates that the intensity decreases in relation to the distance (D) 910 away from the surface, i.e., Intensity Plot=1/D³.

FIG. 13B shows the Transmitter induced magnetic flux field 140, 141, 142 and 143 when the Saturation Inducer 500 is turned on. There is a concentration of the flux lines off the centerline 910 and Magnetic Lensing occurs in a different geometry from FIG. 12. The shape of the Transmitter induced magnetic flux field has changed. The focused flux fields create a “Focal Circle” 187 or “Focal Plane” instead of the focal point 186 geometry illustrated in FIG. 12.

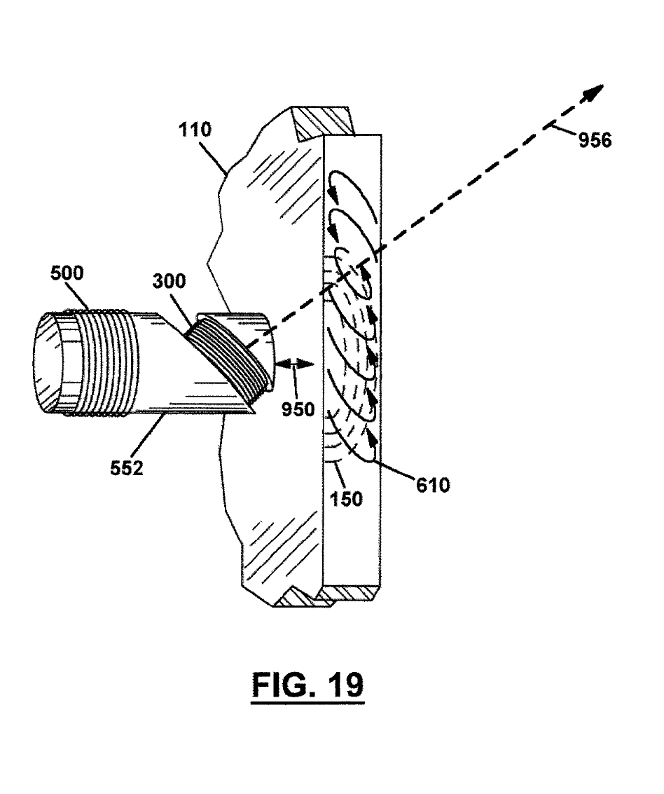

There are advantages to winding the Transmitter coils 300 in this manner with respect to the surface of the Well Casing 110. The main advantage is that all elements of the Transmitter coils can be made equidistant from the surface of the Casing 110, therefore inducing an eddy current uniformly parallel or perpendicular to the surface of the Well Casing and inducing a symmetrical magnetic flux field. If non-uniform eddy currents were desired, then it would be possible to rotate the axis of the Transmitter coil 300 to be some angle between perpendicular (as in FIGS. 11 and 12) or parallel (as in FIGS. 13A and 13B) to the metal plate. (This geometry is illustrated in FIG. 19.)

It will be appreciated that there is an eddy current generated in the core 552 and opposing the Transmitter Current. As the Transmitter coil 300 is moved axially along the core 552 and away from the end of the cylindrical core, more of the energy of the Transmitter is consumed by this opposing eddy current. Note that this decrease of Transmitter energy is experienced in spite of the gap 950 between the core 552 and the Casing 110 remaining relatively constant.

Using this Magnetic Lensing technique allows the Transmitter power to be minimized yet allows resistivity measurements at distances within the Geologic Formation not possible without the consumption of much greater power and increased size of the Magnetic Transparency Generator subject of this invention.

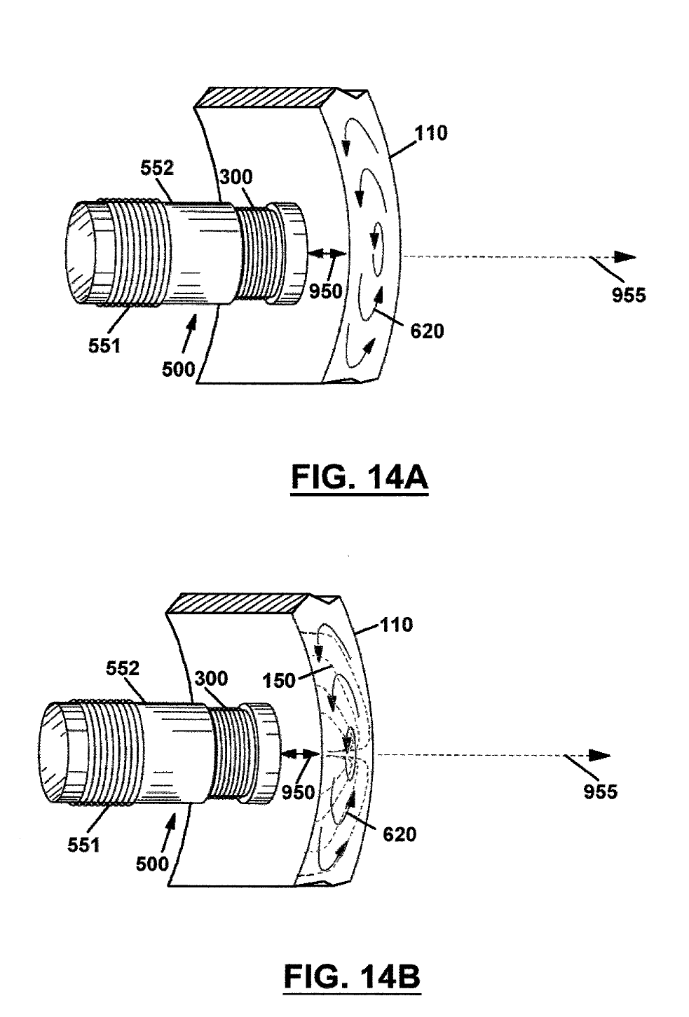

FIG. 14A and FIG. 14B illustrate another embodiment of the invention with the curved Well Casing surface 110. It will be appreciated that, for configurations of the Logging Tool optimizing a compact structure, achieving increase energy efficiency and using nested Receivers and Transmitters, the effect of the curved surface of the Casing will be minimized and the Lensing effect illustrated in FIGS. 12 and 13B will be increasing applicable. It will also be appreciated that known techniques for creating flexible ferromagnetic shapes of parabolic or similar geometry may be used to allow adjustment of the magnetic focal distance.

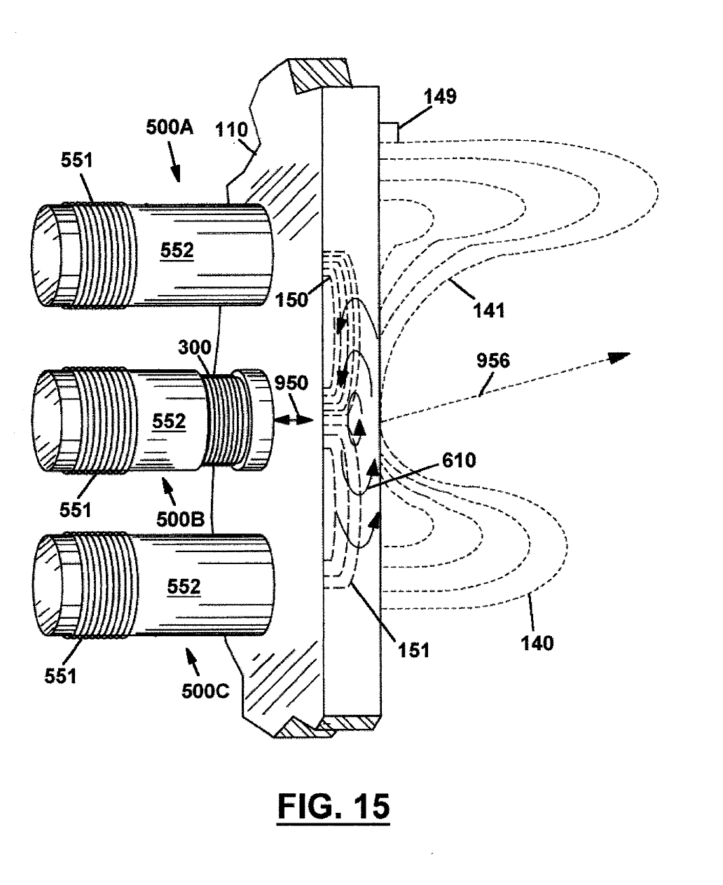

FIG. 15 shows beam directivity and steering capabilities by an inter-play of a plurality of Saturation Inducers, e.g., 500A, 500B and 500C and one Transmitter 300. In this Figure, the Saturation Inducer 500A and 500B are creating the maximum permeability reduction within the Well Casing 110 proximate to Transmitter 300 and Saturation Inducer 500A This creates the maximum bending of the flux lines 140-143 induced by Transmitter 300 towards Saturation Inducer 500A . There is a maximum beam steering available by this single Transmitter technique.

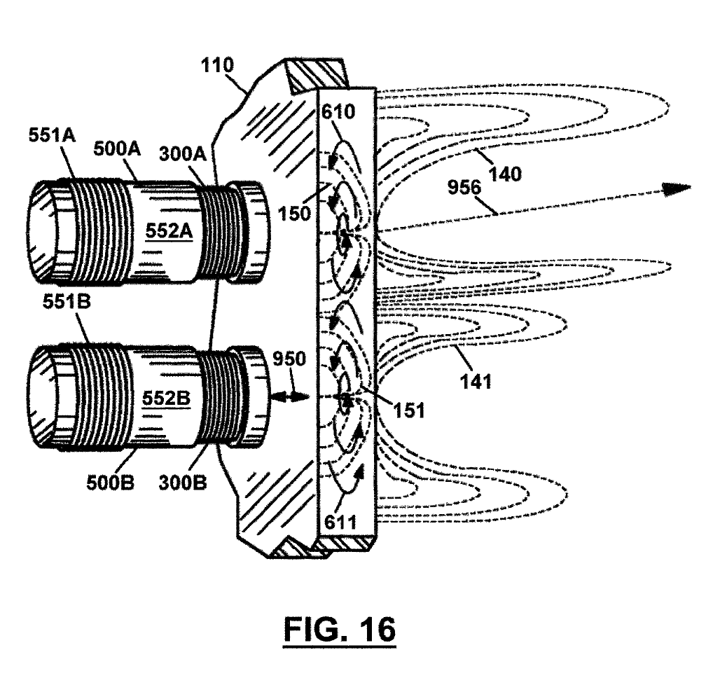

FIG. 16 shows two Transmitters, 300A and 300B with bucked Transparency magnets 551A and 551B. The Transmitters are both wound with their coils substantially parallel to the Casing 110. To deflect the Transmitting Current 150 and 151 from 300A to the top, Transmitter 300B should be increased in strength (at the same frequency) and Transparency Current of 500B must be increased over Transparency Current of 500A.

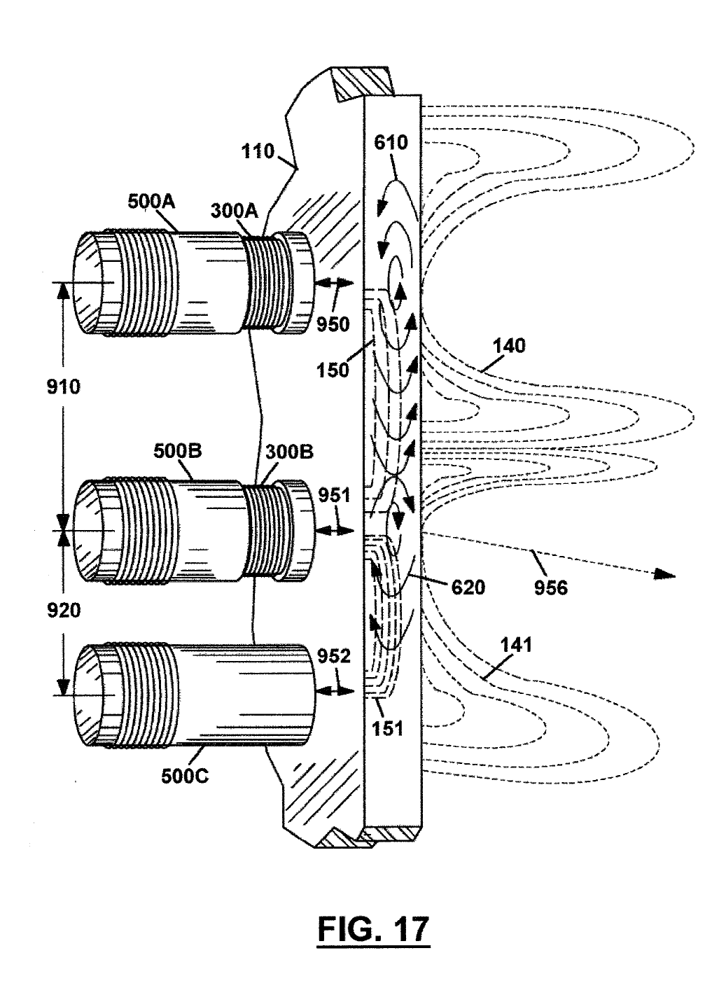

In FIG. 17, another Transparency magnet 500C is added to increase the current to the distance D_{2,3}. 910. This will bend the flux field 140-143 downward while Transmitter 300A is made much more powerful than Transmitter 300B to push the flux field down.

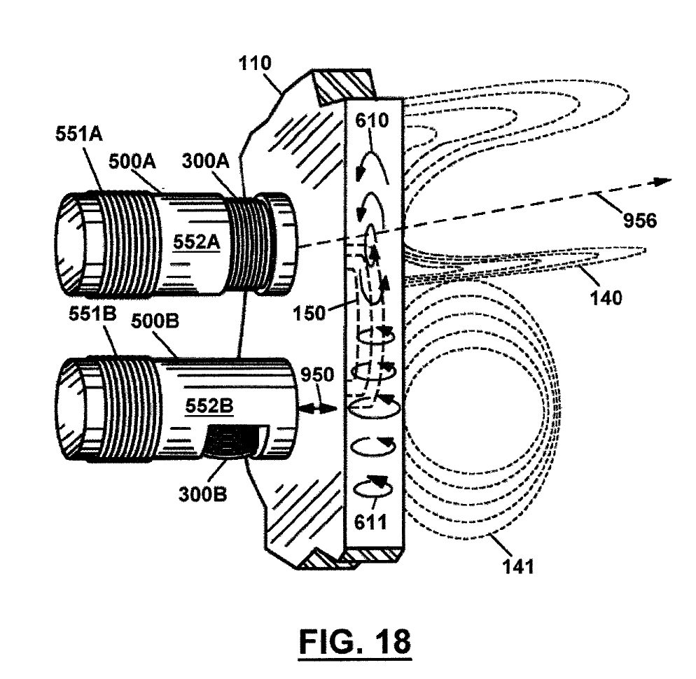

In FIG. 18, another embodiment of the invention relating to beam movement is shown. This embodiment utilizes the Transmitters 300A and 300B having equal diameters but oriented at 90° to the other. Again, it is possible to use combinations of Transmitters and Magnetic Transparency Generators 500A and 500B having unequal saturation strengths to bend the flux field.

FIG. 19 shows the Transmitter 300 at an oblique angle to the Well Casing 110. It is also oblique to the Transparency Coil 551 and Transparency Core 552. The Well Casing is not fully saturated and the oscillating magnetic flux field of the Transmitter 300 induces eddy currents 610. These eddy currents are also at an oblique angle to the surface of the Casing 110. Further, the eddy currents 610 induce a corresponding Magnetic Flux Field radiating out of the Well Casing 110. It should be noted that the field lines do not extend out of the Casing toward the Saturation Inducer but rather field lines stay in close proximity of the Casing surface.

In regard to the Conductivity/Resistivity Measuring System of the present invention, it is possible to greatly improve existing methods of measuring electrical conductivity of the geologic formation by using a spectrum of frequencies rather than one frequency. In addition, the metallic permeability must be measured to accurately depict the effects of the Well Casing upon the measurement of conductivity. Using a range of frequencies allows a single device to function where the Casing thickness may vary from zero (no metal) to multiple inches thick. Using the same frequency over such a wide range causes a large loss of resolution and accuracy. Therefore, for a given range of material thickness, a particular group of frequencies will provide improved resolution and better accuracy.

To eliminate the effects of a varying metallic permeability, it is necessary to create a local Metallic Transparency with the permeability as close to unity as possible while the Transmitter frequency is being varied. Then, while the Transmitter frequency is held constant, changing the amount (amplitude) of the Saturation Current will vary the permeability of the Casing or other Barrier Material.

One embodiment of the present invention as broadly described herein is a method for creating a spectral EM frequency metallic thickness measurement using Metallic Transparencies. In order to calculate the thickness of a Casing or other Barrier Material with unknown permeability and conductivity, empirical testing is used to first approximate the conductivity and permeability. Conductivity and permeability can be approximated in any order using techniques herein discussed.

As the frequency increases, the conductive losses increase until the skin depth becomes much less than the thickness of the Barrier Material. As used herein, “skin depth” is proportional to the inverse of the square root of the product of permeability, conductivity and frequency.

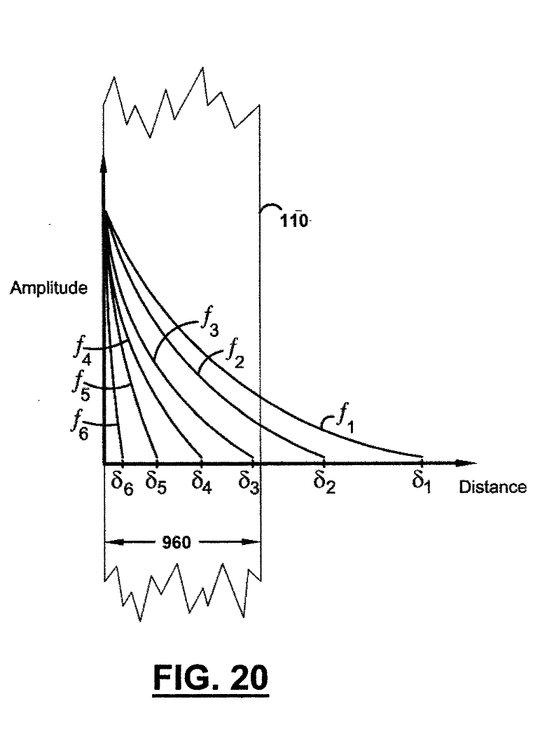

FIG. 20 illustrates the relationship between signal frequency and penetration depth for a cross-section of a piece of metal with a conductivity, a permeability and several imposed frequencies fₓ, for the present invention. For a wave of constant amplitude and varying frequency, and a metal with the same permeability and conductivity, it is known by skin depth theory that a lower frequency penetrates deeper than a higher frequency. Therefore, one can find an optimum frequency range that can characterize the metal conductivity. For constant length L and varying frequencies, the penetration depth δ is:

$$δ = ( \frac{1}{e} ) L$$

and

$$δ = \frac{1}{\sqrt{{σμ}_{r} {μ}_{o} f}}$$

where

δ=penetration depth,

f=frequency,

σ=conductivity

μᵣ=relative permeability, and

μₒ=absolute permeability.

In FIG. 20, the relationship of frequencies is

f₆>f₅>f₄>f₃>f₂>f₁.

The first step to calculate the thickness of the Casing is to generate a magnetic flux adjacent to or near the Casing to be measured. The magnetic flux must be of sufficient magnitude to saturate the Casing. The Saturation Current may be generated by a permanent magnet, an electromagnet powered by DC current or AC current. The AC powered EM waves will preferably be of a relatively low frequency. Upon achieving saturation of a portion of the Casing, a second magnetic flux is generated with specific constant amplitude and engaged with the saturated Casing. The resulting magnetic signal from the Casing is monitored using a Receiver. The Receiver is located adjacent to or near the Casing to be measured. The Receiver may be either co-located with the Transmitter or at a distance away, e.g., as in a bistatic configuration. The Transmitter frequency is increased incrementally while the amplitude is held constant and the received signal is monitored.

As required by skin depth theory, for a given wave of constant amplitude and varying frequency, the lower frequencies penetrate deeper into a piece of Casing than the higher frequencies. The higher the frequency, the greater loss of signal, i.e., increased attenuation. See FIG. 20. Therefore, an oscillating magnetic flux of a specified frequency can be generated and engaged with the Well Casing. The received signal is monitored. The frequency of the Transmitted Flux is increased in a stepped fashion while continuing to monitor the received signal. The amplitude of the Transmitted Signal remains constant. As the frequency of the Transmitted Signal is incrementally increased, for example by stepping, the received signal will attenuate. With the amplitude held constant, the maximum frequency of the Transmitter Signal capable of penetrating the Casing is therefor determined when the Receiver is no longer able to detect a signal. The last frequency to generate a received signal is the “maximum penetration frequency.” The Maximum Penetration Frequency is used in the present invention to determine material thickness.

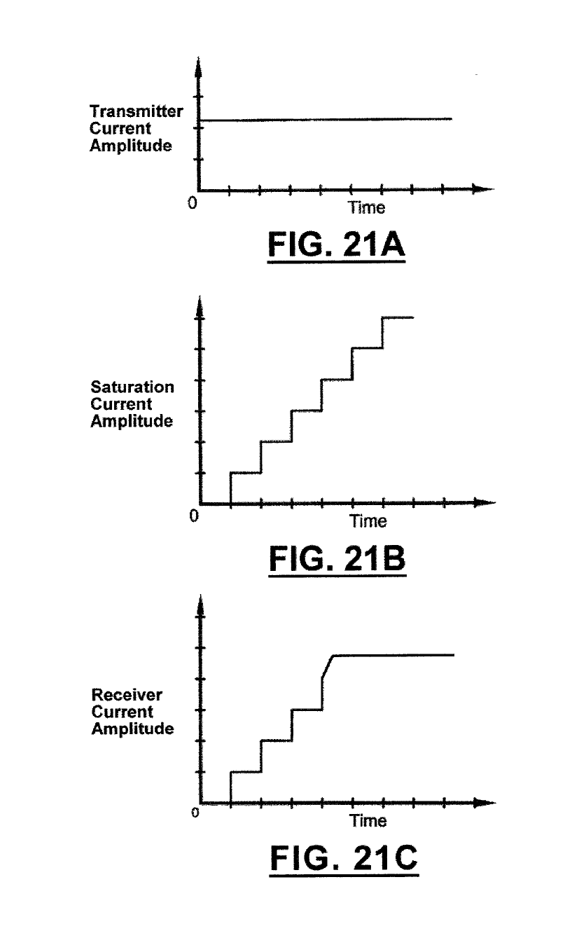

The second step in calculating the thickness of a material with unknown permeability and conductivity is the approximation of permeability. Using the same Transmitter, Receiver, and saturation procedures described in the first step, a Saturation Flux is generated near or close to the Well Casing to be measured. The Saturation Flux has a known yet variable current. A Transmitter Flux of known and constant frequency and amplitude is generated at or near the Well Casing within a zone to be effected by the Saturation Flux. A Receiver monitors the Receiver Signal from the transmitted signal returning for generating a resulting electromagnetic response. While monitoring the received response and holding the Transmitter Flux frequency and amplitude constant, the Saturation Current is increased incrementally. Thus, the Receiver Signal will generally mirror the steps of the Saturation Flux but at different amplitudes than the Transmitter Flux. (See FIGS. 21B and 21C.) As the Saturation Flux increases, the Well Casing becomes more and more transparent to the Transmitter Flux (maintained at constant amplitude and frequency), thus, causing the amplitude of the Receiver Signal to increase proportional to the stepped increases in the Saturation Flux. The stepped incremental saturation is continued. while the Transmitter Flux is held at the constant amplitude and frequency and the resulting increments in the Receiver Signal are monitored. This is continued until no further changes are registered by the Receiver in response to increases in the Saturation Flux. The point at which the received signal registers no change may be called “total saturation.” See FIG. 21C. Once Total Saturation is achieved, increases in the current or amplitude of the Saturation Flux have no effect upon the Received Signal. Thus, the Transmitter Flux is coupled with the Casing. As the Casing becomes more saturated, (and its permeability approaches 1) the Casing becomes increasingly transparent, resulting in more of the Transmitter Flux penetrating though the Casing. The current history and the associated received signal, as illustrated in FIGS. 21A, 21B and 21C, provide for full or partial saturation of a localized area. Further, the current history and the received signal information can be used to mathematically determine the permeability and thickness. Once approximation is obtained on either permeability or conductivity, the other variable can be determined and the material thickness can then be calculated.

The technique of the present invention for calculating the thickness of a material with unknown permeability and conductivity can be used to further classify various materials (and the thickness of such materials) such that a general lookup table can be created. The general lookup table can contain known results from numerous test samples allowing for quick lookup and display of thickness based on known samples meeting the test criteria. The test criteria can be for a range of thickness for specified materials having the same permeability and conductivity.

It order to obtain an accurate measurement of permeability and/or conductivity, electronic and geometric nulling are required. Geometric nulling positions the Transmitter, Receiver and Saturation Coils in the optimum locations for the particular system designed. Various designs are provided yielding excellent results. Also, an electronic nulling circuit can simultaneously null all of the frequencies at once. Pursuant to practicing the present invention as described herein, one skilled in the art will know and appreciate how to arrange the Transmitter, Receiver and Saturation Coils in optimum locations for the particular system being used, and will know and appreciate how to simultaneously null all of the frequencies at once to provide electronic nulling.

FIG. 5D illustrates one embodiment of a Magnetic Transparency Generator 501 used to generate the Transparency Current required to practice the present invention. The Transparency Current Generator 501 is utilized to completely saturate the intended Well Casing 110 volume region 600.

In FIG. 22, the bistatic Logging Tool 500 consists of two separate Magnetic Transparency Generators 593 and 595 contained within a housing 109. The Magnetic Transparency Generator 593 incorporates a Receiver with a Receiver Coil 581 wound orthogonal to the Saturation Coil 551. The Magnetic Transparency Generator 595 incorporates a Transmitter 300 with the Transmitter Coil 301 wound parallel to the Saturation Coil. The distance between the Receiver Coil 581 and the Transmitter Coil 301 is the distance “D” 910. The Logging Tool 500 is in operative association with a Well Casing 110 having a defect 599A. It can be appreciated by those skilled in the art that in the bistatic configuration illustrated in FIG. 22, the distance D must be sufficiently small relative to the geometric size of the defect 599A in order that the Logging Tool may detect the defect. Accordingly, the accuracy of the casing thickness calculation is limited by the mass to be evaluated and the displacement distance “D” 910.

The limitation of the displacement distance can be essentially eliminated by a utilization of a single Magnetic Transparency Generator as illustrated in FIGS. 5E and 7 in operative association with a Magnetic Culminator 555. The Transmitter 300 and the Receiver 580 are both on the same Culminator 555. The displacement distance D between the Transmitter 300 and the Receiver 580 is essentially zero because of the close configuration of the Transmitter and Receiver. In the illustrated configurations the Receiver and Transmitter are geometrically nulled. The configuration illustrated by FIG. 7 has the additional advantage of adaptation to the adjustable nested configuration of FIG. 10B wherein the Saturation Core is replaced with a Magnetic Culminator. The intensity of the frequencies received will show the metal thickness. For example, if all the higher frequencies are attenuated, the metal is thick. If all the high frequencies are detected with little attenuation of the low frequencies, the metal is thin. For a given power, the displacement distance D between the transmitter 300 and the receiver 580 determines the resolution of the thickness measurement. The resolution effects the size of the defect measurable.

Also, FIGS. 5A through 5E illustrate alternate embodiments of the Metallic Transparency Generator 501 for use with the present invention. The Metallic Transparency Generator illustrated in FIG. 5A comprises flux circuit core 552 upon which the Saturation Coil 551 is wound, two like magnetic poles 504 between which is a Magnetic Culminator 555. The core 552, upon which the Saturation Coils 551 of the electromagnet are wrapped, is located between each pole 504 and the Culminator 555. Preferably, the Magnetic Transparency Generator is contained within a housing (not shown) and connected to the power source and instrumentation by conventional means, (also not shown). It will be noted and appreciated by persons skilled in the technology that the Magnetic Transparency Generator 501 is not in contact with the Well Casing 110.

The complete Magnetic Transparency Generator 501 incorporates the Flux Circuit Core 501 for providing a Metallic Transparency that is illustrated having a width W 920, a height H 930 and a thickness L 960. The Transparency may be termed the Target Area. It is appreciated that the Transmitter Coils 300, the Receiver Coils 580 and the Transparency Coils 551 of the Magnetic Transparency Generator 500 are nulled to each other.

FIG. 5C illustrates one embodiment of the Logging Tool 500 of the present invention. The Logging Tool 500 comprises the Saturation Coil 551, the Transmitter Coil 300, Receiver Coil 580 and the Well Casing 110. The Magnetic Transparency Generator 501 is disposed from the Well Casing 110 by a gap G 150. The Well Casing 110 has a thickness L 160. The Logging Tool 500 operates by energizing the Saturation Coil 551 for saturating the Well Casing 110, transmitting a Transmitter Signal from the Transmitter Coil 300, and receiving a response via the Receiver Coil 580. The relative penetration is caused by the change in the Saturation Current. Thus, as the Saturation Current increases from i₁, to i₂, to i₃, to i₄ then the penetration depth increases from δ₁, to δ₂, to δ₃, to δ₄, respectively. FIG. 5C illustrates the incremental increase in penetration by the field lines F₁, F₂, F₃ and F₄. Also, consideration of the cross-sectional area of each component of the Logging Tool 500 is required to assure that no component goes into total saturation for a specific power requirement necessary to drive the Magnetic Flux across the gap G 950.

FIG. 22 illustrates one embodiment of a bistatic Magnetic Transparency Generator 501 of the present invention. Using the bistatic Magnetic Transparency Generator 501 shown in FIG. 22, the permeability is driven to unity. Oscillating Transmitter Flux of differing frequencies are transmitted by the Transmitter 300 and related induced magnetic flux signals are monitored with the Receiver 580. A Metallic Transparency is created by the Saturation Flux of the Magnetic Transparency Generator in a portion of the Well Casing 110. An oscillating Transmitter Signal is generated using the Transmitter 300 at a preset frequency and constant amplitude. Assuming the first frequency is within the detectable frequency range, the frequency is increased incrementally until the received signal is lost. The last frequency detected prior to losing the received signal determines the Maximum Penetration Frequency detectable in a certain piece of Well Casing 110 of constant thickness, permeability, and conductivity. Using the data and information received in empirical testing for permeability, the material properties and thickness can be very precisely calculated.

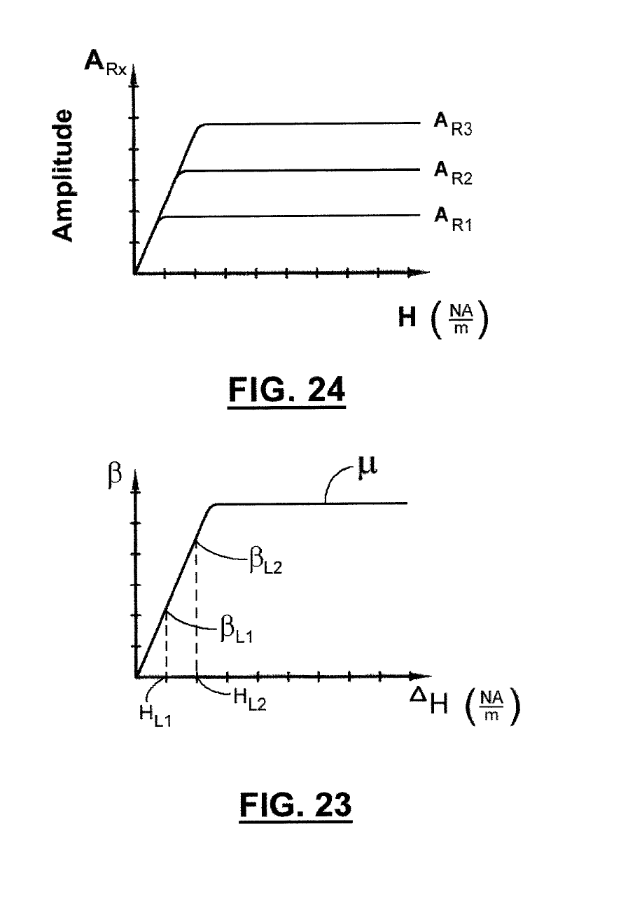

FIG. 23 illustrates the relationship between the flux field β and the change in H (ΔH) in amp-turns/meter. The permeability μ is plotted. For the relationship between the flux field β and ΔH, the function defining the permeability μ remains the same. Although the function defining the permeability μ remains the same, the value of ΔH for thinner materials moves up the curve faster. Thus, incremental changes in H create a faster advancement up the permeability curve toward saturation. For example, a given H_{L1} corresponds to the value of β_{L1} and a corresponding H_{L2} corresponds to the value of β_{L2}. Thus, the value for L2 moves faster up the permeability μ curve than the value for L1.

FIG. 24 illustrates the relationship between the amplitude A_{Rx} of the Receiver Signal and H in amp-turns/meter. As in FIG. 23, the slope of the curve in FIG. 24 is related to the permeability μ. However, the Receiver amplitude A_{Rx} reaches a different maximum value depending on the thickness of the Casing. For thinner Casing, as with other materials, the Receiver amplitude A_{Rx} reaches its maximum value at a lower amplitude A_{Rx}. For thicker materials, the Receiver amplitude A_{Rx} reaches its maximum value at a higher amplitude A_{Rx}. FIG. 24 illustrates a thinner material having a maximum at A_{R1}, a thicker material having a maximum at A_{R3}, and an intermediate thickness material having a maximum at A_{R2}.

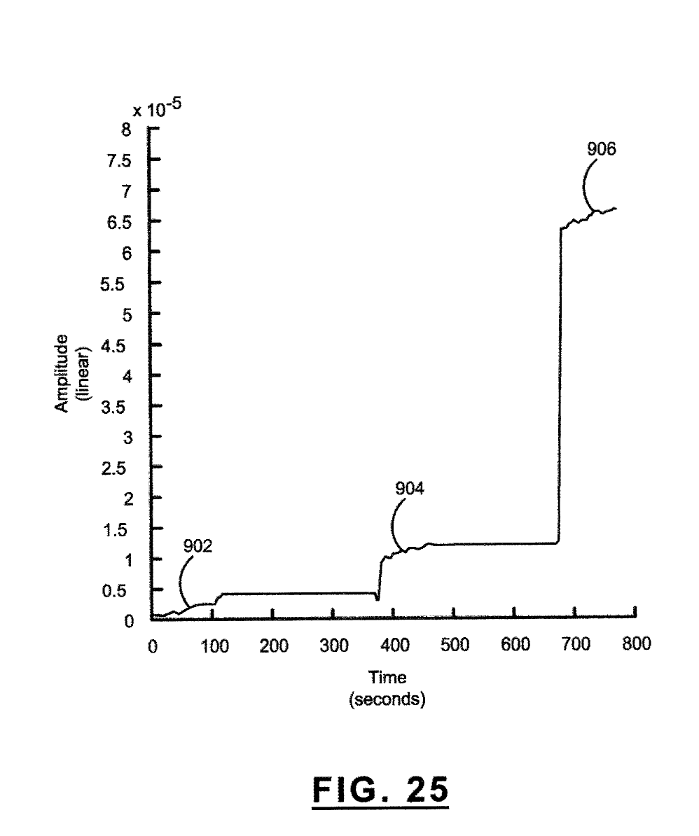

FIG. 25 is a graph of amplitude versus time for a bistatic configured magnetic transparency generator of the present invention. The frequency is held constant (fixed) and the Barrier Material, also of constant thickness, and is varied. The bistatic magnetic transparency generator was nulled using copper 902. Thereafter, the copper was replaced with brass causing the amplitude to vary from the original nulled position 904 to a new position 904. Since brass and copper have related properties, the dislocation 904 from the copper nulled position 902 is small. However, when the brass is replaced with aluminum the amplitude 906 varies significantly from the original nulled position 902. Aluminum and copper have significantly different physical characteristics.

### METHOD OF PROCEDURE

As the Logging Tool moves through the axial length of the Well Casing, a number of procedures are carried out in the following manner at a particular point.

The value of the Casing permeability is measured by varying the “H” field by increasing the magnetic coils current by fixed amounts.

The Casing conductivity is measured by varying the frequency over some known values.

Using the permeability and conductivity, the Casing thickness may be calculated from the thickness algorithm.

The automatic lensing algorithm will now measure the resistivity with a particular setting for the transmitter power and the magnetic power.

The resistivity reading is adjusted by the permeability and conductivity values.

The corrected resistivity is corrected to a reference resistivity by comparison to a reference inductor.

The tool is now ready to move to the next position.

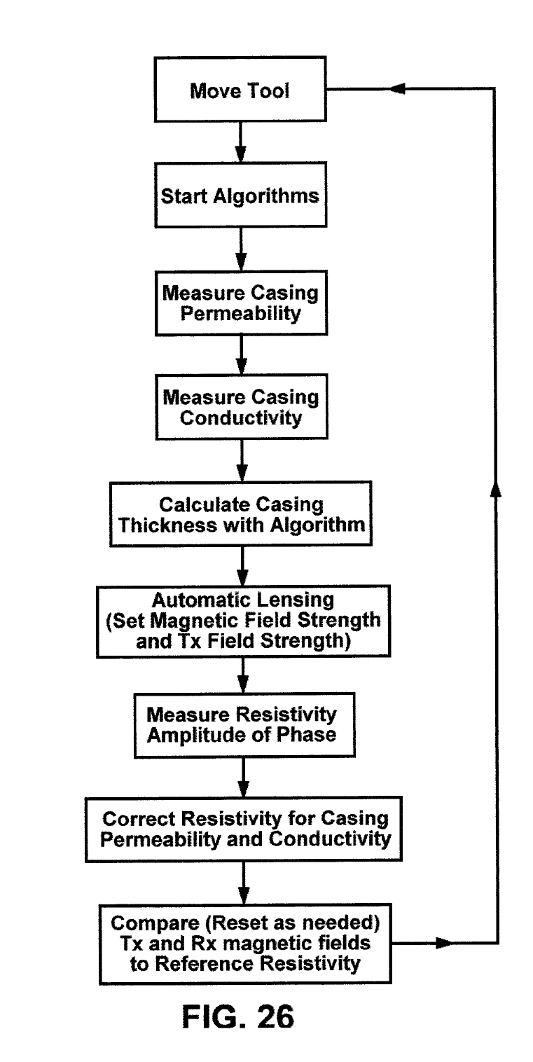

This sequencing is also shown in FIG. 26.

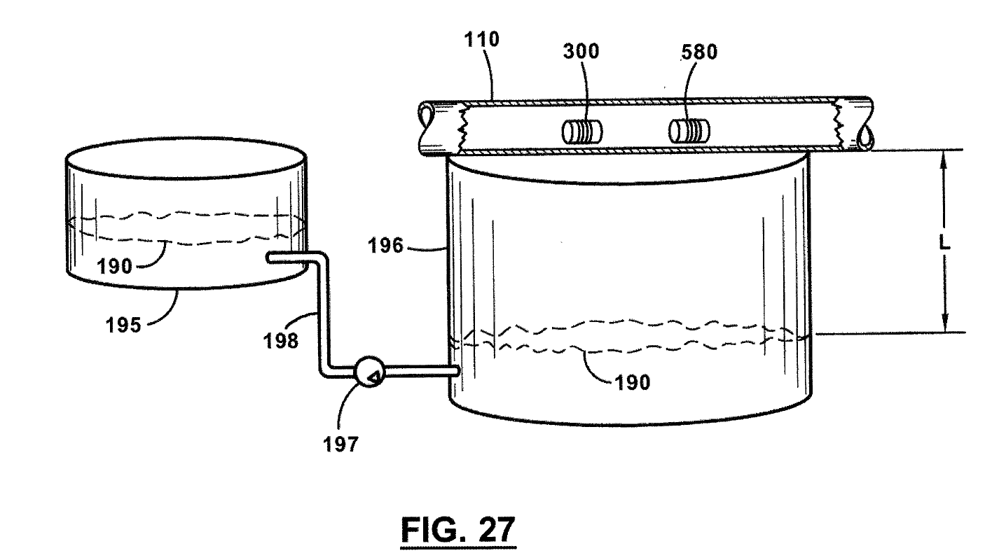

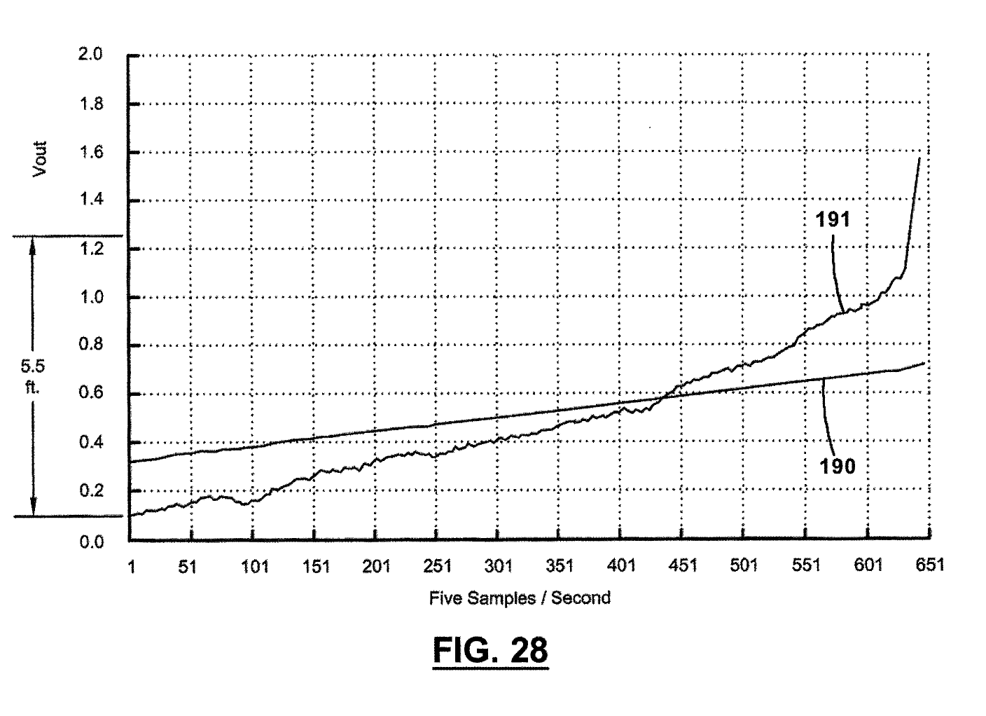

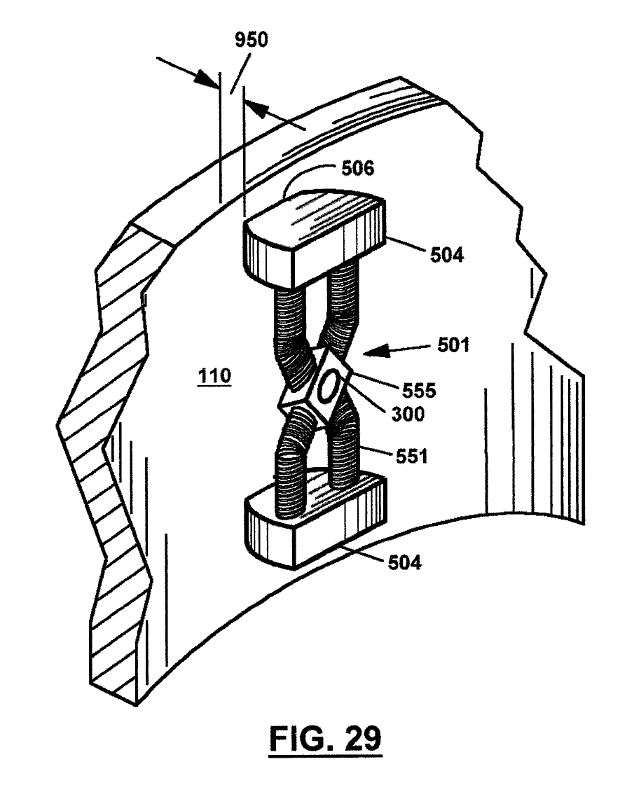

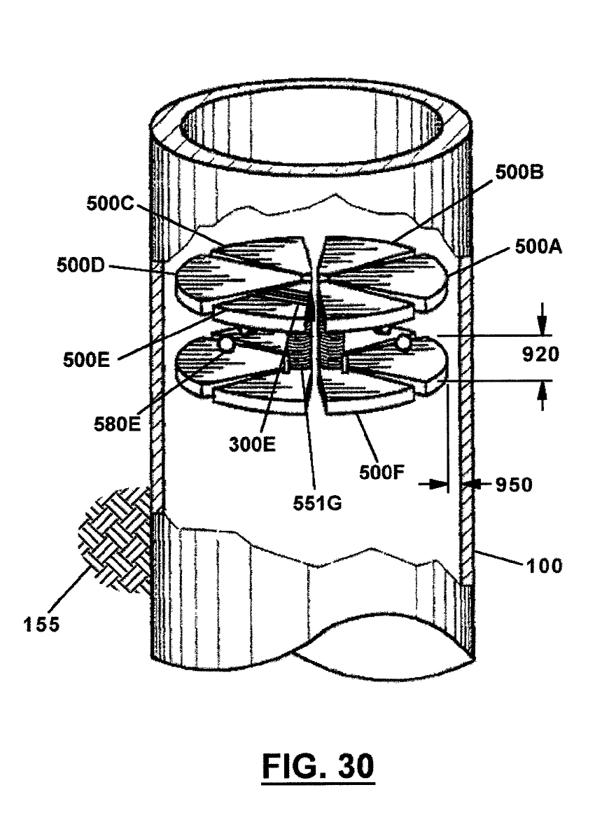

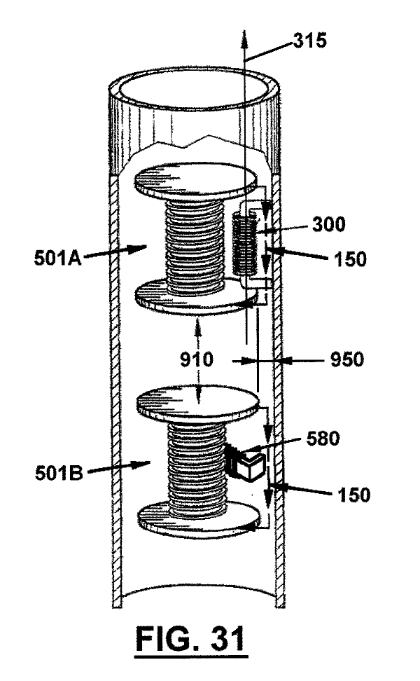

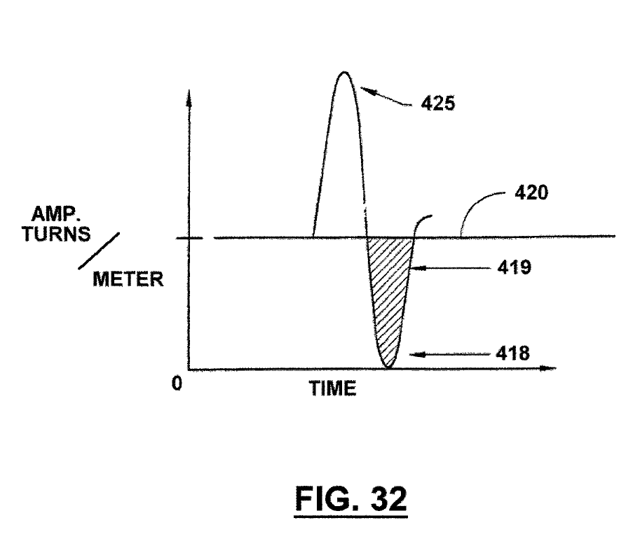

FIG. 27 illustrates the apparatus used to demonstrate the invention. Receiver means 580 and Transmitter means 300 were placed in a section of ferromagnetic metal pipe. A Saturation Coil (not shown) generated a Metallic Transparency proximate to the Transmitter and Receiver. This configuration of components within the metal pipe was placed above a tank 196. The apparatus was activated and measurements were taken of the resistivity of the media below the pipe. Water was added to the tank from an opening at the bottom by means of piping 198, valve 197 and second tank 195. This caused the level of the water 190 to rise in the tank 196 below the pipe. As the surface of water approached the pipe, the measured values of resistivity changed. FIG. 28 shows the change in measured resistivity 191 compared to the change in water level 190.

The given description illustrates that the test apparatus has demonstrated the capability to analyze/measure the resistivity in the producing zone just outside the casing for a distance of at least 4 feet. By taking these measurements continuously or over short intervals, the resistivity can be trended. Trending makes it possible for the operator to see very slight changes in resistivity, and will signal even slightly higher concentrations of water in the hydrocarbon reservoir. The invention provides unique information that is important both to the reservoir engineer and to the production engineer, by providing both realtime information and historical trends, useful in managing the production zone and its flows. The present invention also provides information useful in defining the surrounding geology or detecting changes in the geologic formation.

In the foregoing description, a single power level, frequency, and direction is discussed. However, the apparatus can be readily modified by varying the strength and frequency of the transmitted signals, and by adding transmitter/receivers in multiple directions or at different spacing, or by adding complete sets of additional down hole devices at multiple production zones. The apparatus may also be modified in a manner to allow it to contain its own power source. This power source can be a stored electrical power source such as one or more batteries. The apparatus may also incorporate powered devices to propel the apparatus along the axial direction of the Casing. It will be appreciated that this would be of particular benefit when the apparatus is in a substantially horizontal portion of the cased well bore. This capability may also facilitate use of the apparatus in portions of a cased wellbore that contain directional changes. This propulsion capability can be a supplemental means existing means for moving the apparatus through the Well Casing. It may, in other embodiments provide the single means for movement of the apparatus. When combined with data recording and storage capabilities, the apparatus could operate independent of any attachment to the well head. The means for propelling the apparatus along the Well Casing may include wheel or track devices separately attached to or incorporated into the housing of the apparatus.

The apparatus may also utilize one or more permanent magnets to provide the Saturation Flux. One benefit from the use of permanent magnets is that the electrical power requirements would be less.

Additional embodiments of the apparatus may utilize means to maintain a constant distance between the apparatus and the Well Casing proximate to one or more of the Saturation Inducers. This component may be termed a constant distance control device. This device may employ non conductive or non permeable materials to provide this contact. It will be appreciated that contact between this device and the Well Casing is not for the purpose of transmitting electrical or magnetic energy from the apparatus into the Well Casing. The constant distance control device may also include one or more flexibly tensioned attachments, such as wheels or tracks held by springs. These attachments may also not to be electrically conductive or magnetically permeable. When the apparatus of the this invention includes a cylindrical housing or other shape, the these attachments may be positioned on the circumference or perimeter of the housing (or to an auxiliary device attached to the housing) in a manner that the flexible tension device keeps the constant distance control means in contact with the interior surface of the Well Casing.

In another embodiment of the invention subject of this specification, a single electrically conductive coil may be used to provide the Saturation Flux and the Transmitter Signal. The coil would first be powered with dc current sufficient to create the magnetic flux required for saturation of the Well Casing. The power could then be switched to ac current and multiple wavelengths of oscillating magnetic flux be emitted into the Well Casing. The power could then be returned to the dc current providing the Saturation Flux. This alternating powering could be repeated in rapid succession, thereby conserving power and space and weight requirements for the device. The Receiver could also be located proximate to the Metallic Transparency created by the dual saturation and transmitter coil. Accordingly, a separate Saturation Coil would not be required to create the Transparency needed detecting magnetic flux transmitted from the exterior of the Casing. This would provide a further reduction of weight, energy and space.

For this embodiment, it will be appreciated that the ac frequency can be controlled and adjusted. It will be appreciated that use of low frequency ac generated magnetic flux will reduce impedance mismatch.

Further modifications and alternative embodiments of this invention will be apparent to those skilled in the art in view of this specification. Accordingly, this specification is to be construed as illustrative only and is for the purpose of teaching those skilled in the art the manner of carrying out the invention. It is to be understood that the forms of the invention herein shown and describe are to be taken as the presently preferred embodiments. Various changes may be made in the shape, size and arrangement of parts. For example, equivalent elements may be substituted for those illustrated and described herein and certain features of the invention may be utilized independently of the use of other features, all as would be apparent to one skilled in the art after having the benefit of this description of the invention.

What is claimed is:

1. A logging tool for measuring electrical resistivity of geologic formations through an electrically conductive and magnetically permeable well or bore hole casing comprising:
(a) a saturating means for (i) generating a magnetic flux, and (ii) engaging the magnetic flux with a portion of the casing without physical contact between the saturating means and the casing, for (iii) creating at least one magnetically saturated portion of the casing extending through the thickness of the casing;
(b) a transmitter means for generating and transmitting an oscillating magnetic flux through the saturated portion of the casing; and
(c) a receiver means for detecting the oscillating magnetic flux transmitted from the exterior of the saturated portion of the casing.

2. The apparatus defined in claim 1 wherein the transmitter means and the receiver means are proximate to the saturated portion of the casing.

3. The apparatus defined in claim 1 further comprising means for moving the apparatus through the axial direction of the casing.

4. The apparatus defined in claim 3 further comprising at least one housing to contain the saturating means, the transmitter means and the receiver means.

5. The apparatus defined in claim 4 wherein the housing comprises at least one of a non-magnetically permeable material and a non-electrically conductive material.

6. The apparatus defined in claim 4 wherein the housing comprises non-magnetically permeable material.

7. The apparatus of claim 6 wherein the housing comprises stainless steel.

8. The apparatus defined in claim 4 wherein the housing comprises non electrically conductive material.

9. The apparatus defined in claim 1 further comprising at least one separately located power source.

10. The apparatus defined in claim 1 further comprising at least one means separately located from the saturation means, transmitter means and receiver means for receiving an electrical signal corresponding to the oscillating magnetic flux detected by the receiver means and connected to the receiver by means to transmit such electrical signal.

11. The apparatus defined in claim 10 further comprising means to display the received electrical signal and the location of the receiver in the axial length of the casing.

12. The apparatus defined in claim 10 further comprising means to record the received electrical signal and the location of the receiver.

13. The apparatus defined in claim 11 further comprising means to record the received electrical signal and the location of the receiver.

14. The apparatus defined in claim 1 further comprising electrical power storage means to provide electricity for generating, transmitting and receiving magnetic flux.

15. The apparatus defined in claim 14wherein the electrical power storage means is at least one battery.

16. The apparatus defined in claim 15 further comprising means to record the electrical signal received and the location of the housing within the axial length of the casing.

17. The apparatus defined in claim 16 further comprising means to move the housing within the casing without mechanical attachment to a separately located control.

18. The apparatus defined in claim 1 wherein at least one of the transmitters is located proximate to the saturation means and at least one receiver means is located proximate to another saturation means.

19. The apparatus defined in claim 1 further comprising transmitting a plurality of differing frequencies of oscillating magnetic flux.

20. The apparatus defined in claim 19 wherein the differing frequencies of oscillating magnetic flux are transmitted simultaneously.

21. The apparatus defined in claim 19 wherein the differing frequencies of oscillating magnetic flux are transmitted sequentially.

22. The apparatus defined in claim 1 wherein a plurality of saturation means, transmitter means and receiver means are horizontally oriented in different directions.

23. The apparatus defined in claim 1 wherein (i) the saturation means engages the interior side of the casing with magnetic flux but does not saturate the casing through to the exterior side, (ii) the oscillating magnetic flux generated and transmitted by the transmitter means induces eddy currents within the partially saturated portion of the casing, (iii) receiver means detects oscillating magnetic flux generated within electrically conductive media located exterior to the casing by eddy currents induced within the media by the oscillating magnetic flux emitted from the partially saturated casing.

24. The apparatus defined in claim 23 further comprising means to modify the partially saturated area of the casing in a controllable manner in order that the oscillating magnetic flux emitted from the exterior side of the partially saturated casing is directed in an intended manner.

25. The apparatus defined in claim 23 further comprising means to change the shape of the partially saturated area.

26. The apparatus defined in claim 23 further comprising means to modify the permeability of the partially saturated casing.

27. The apparatus defined in claim 23 further comprising means to modify the partially saturated casing in relation to the saturation of the casing proximate to one or more receivers.

28. The apparatus defined in claim 23 further comprising a lens device between the transmitter means and the casing to modify the direction of the oscillating flux emitted from the exterior of the casing.

29. The apparatus defined in claim 28 further comprising the lens device contained within the housing.

30. The apparatus defined in claim 23 wherein the means to control the saturation means reduces the electric power utilized by the saturation means.

31. The apparatus defined in claim 1 wherein the magnetic flux generated by the saturating means is at a constant amplitude.

32. The apparatus defined in claim 1 wherein the saturation means and the transmitter means utilize the same electrically conductive coil.

33. The apparatus defined in claim 1 wherein the saturation means utilizes a dc electrical power and the transmitter means uses ac electrical power.

34. The apparatus defined in claim 1 wherein the saturation means comprises a permanent magnet.

35. The apparatus defined in claim 1 further comprising means to measure the conductivity of the casing proximate to the logging tool.

36. The apparatus defined in claim 1 further comprising means to measure the permeability of the casing proximate to the apparatus.

37. The apparatus defined in claim 35 further comprising means to measure the thickness of the casing proximate to the logging tool.

38. The apparatus defined in claim 1 further comprising a means to null the transmission of signals directly from the transmitter means to the receiver means.

39. The apparatus defined in claim 38 wherein the nulling means comprises geometric nulling.

40. The apparatus defined in claim 39 wherein the receiver is configured on a plane normal to the plane of the transmitter.

41. The apparatus defined in claim 33 wherein the transmitter means and receiver means are separated by magnetically unsaturated material.

42. The apparatus defined in claim 38 wherein the transmitter means is placed upon a material having sufficient mass and magnetic permeability to direct the transmitter flux in a manner to minimize the quantity of transmitter flux reaching the receiver means.

43. A method for detecting electrically resistive media within a geologic formation by transmitting and receiving magnetic flux through an electrically conductive and magnetically permeable casing comprising the steps of:
(a) creating at least one magnetic flux within the interior of the casing using a flux generating means;
(b) engaging the interior side of the casing with the magnetic flux without physical contact between the flux generating means and the casing for creating at least one magnetically saturated area which extends through a thickness of the casing to the exterior side;
(c) creating at least one oscillating magnetic flux;
(d) transmitting oscillating magnetic flux through at least one magnetically saturated area of the casing to induce eddy currents within electrically conductive media located proximate to the exterior side of the magnetically saturated casing; and
(e) using at least one receiver means located inside the casing for detecting oscillating magnetic flux transmitted through the casing that is induced by the eddy currents within the electrically conductive media proximate to the exterior side of the magnetically saturated casing.
